(19) United States
(12) Patent Application Publication
(10) Pub. No.: US 2020/0229069 A1
(43) Pub. Date: Jul. 16, 2020

(54) METHOD FOR PROVIDING LOCATION BASED COMMUNICATION SERVICES IN WIRELESS COMMUNICATION SYSTEM AND APPARATUS THEREOF

(71) Applicant: LG Electronics Inc., Seoul (KR)

(72) Inventor: Sungduck CHUN, Seoul (KR)

(21) Appl. No.: 16/744,815

(22) Filed: Jan. 16, 2020

(30) Foreign Application Priority Data
Jan. 16, 2019 (KR) 10-2019-0005973

(51) Int. Cl. H04W 48/04; H04W 60/04; H04W 76/30; H04W 36/00

(52) U.S. Cl. CPC H04W 48/04; H04W 36/0079; H04W 76/30; H04W 60/04

(57) ABSTRACT

Provided is a method for providing location based communication services to user equipment (UE) in a wireless communication system, the method including: transmitting a registration request message to a network; receiving, from the network, a registration accept message as a response to the registration request message; receiving, from the network, a communication connection release message including restricted area information associated with mobility of the UE; and reselecting a cell based on the restricted area information.

### CROSS-REFERENCE TO RELATED APPLICATIONS

This application is based on and claims priority under 35 U.S.C. 119 to Korean Application No. 10-2019-0005973, filed on Jan. 16, 2019, the disclosure of which is herein incorporated by reference in its entirety.

### BACKGROUND OF THE INVENTION

### Field of the Invention

The present disclosure relates to a wireless communication system for providing communication services to UEs having different mobility than the existing UEs, such as a drone, and more particularly, to a communication system and method for controlling quality of service provided according to information subscribed by a UE and a location of the UE, and controlling an operation of the UE in advance according to a change in quality of communication services based on the controlled quality of service so as to increase stability of the communication services.

### Related Art

In a wireless communication system, mobile communication systems have been developed to provide voice services while ensuring activity and mobility of users. However, coverage of mobile communication systems has been extended to include data services, as well as voice services, resulting in an explosive increase in traffic and shortage of resources. To meet the demands of users expecting relatively high speed services, an advanced mobile communication system is required.

Requirements of a next-generation mobile communication system include accommodation of increased amounts of data traffic, a significant increase in a transfer rate per user terminal, accommodation of considerably increased number of connection devices, very low end-to-end latency, and high energy efficiency. To this end, there have been researched various technologies such as dual connectivity, massive multiple input multiple output (MIMO), in-band full duplex, non-orthogonal multiple access (NOMA), super wideband, device networking, and the like.

### SUMMARY OF THE INVENTION

According to an aspect of the present disclosure, a method for providing location based communication services to user equipment (UE) in a wireless communication system is provided. The method includes: transmitting a registration request message to a network; receiving, from the network, a registration accept message as a response to the registration request message; receiving, from the network, a communication connection release message including restricted area information associated with mobility of the UE; and reselecting a cell based on the restricted area information.

The restricted area information associated with the mobility of the UE may include a cause for the network to transmit the communication connection release message.

In the reselecting of the cell, a cell that does not correspond to the restricted area information associated with mobility of the UE may be preferentially selected.

The method may further include transmitting the registration request message to the network associated with the cell when the UE stays in the cell.

The restricted area information associated with the mobility of the UE may further include information of an altitude to which the communication services from the network are permitted.

The network may support location information of the UE in a three-dimensional space of the UE.

The communication connection release message may be based on the location information in the three-dimensional space of the UE.

In another aspect of the present disclosure, a method for providing location based communication services by a network in a wireless communication system is provided. The method includes: receiving a registration request message from a UE; transmitting, to the UE, a registration accept message as a response to a registration request message; monitoring an environment in which the UE performs communication; and transmitting, to an entity, an alarm message indicating that a connection with the UE may be released, based on the environment in which the UE performs communication and configuration information of the UE stored in the network.

The configuration information of the UE may include (i) information on restricted area in which the UE cannot perform the communication, or (ii) contact information associated with the entity.

The alarm message may be transmitted when a location where the UE performs communication or a location where the UE is expected to perform the communication correspond to a restricted area where the UE cannot perform the communication.

The information on the restricted area in which the UE cannot perform the communication may be set as a value indicating a height or an altitude.

The alarm message may include time information associated with a release of the communication with the UE.

The alarm message may include the information on the restricted area in which the UE cannot perform the communication.

The registration request message may include the contact information associated with the entity.

In another aspect of the present disclosure, a method for receiving communication services from a network by a first UE in a wireless communication system is provided. The method includes: transmitting a registration request message to a network; receiving, from the network, a registration accept message as a response to the registration request message; receiving, from the network, an alarm message indicating that a connection with the UE may be released; and transmitting, to a second UE, a control message for controlling the second UE based on the alarm message.

The method may further include transmitting the contact information of the first UE to the network, in which the alarm message may be received through the contact information of the first UE.

According to another aspect of the present disclosure, user equipment (UE) performing a method for receiving location based communication services in a wireless communication system is provided. The user UE includes: a transceiver; a memory; and a processor that controls the transceiver and the memory, in which the transceiver may transmit a registration request message to a network, receive, from the network, a registration accept message as a response to the registration request message, and receive a communication connection release message including restricted area information associated with mobility of the UE, and the processor may reselect a cell based on the restricted area information.

### BRIEF DESCRIPTION OF THE DRAWINGS

The accompany drawings, which are included as part of the detailed description in order to help understanding of the present disclosure, provide embodiments of the present disclosure and describe the technical characteristics of the present disclosure along with the detailed description.

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4 illustrates various reference points.

FIG. 5 illustrates an example of a network structure of an evolved universal terrestrial radio access network (E-UTRAN) to which the present disclosure is applicable.

FIG. 6 illustrates an example of a general architecture of E-UTRAN and EPC.

FIG. 7 illustrates an example of a structure of a radio interface protocol in a control plane between a UE and eNB.

FIG. 8 illustrates an example of a structure of a radio interface protocol in a user plane between a UE and eNB.

FIG. 9 illustrates an architecture of a general NR-RAN.

FIG. 10 illustrates a functional separation of a general NG-RAN and SGC.

FIG. 11 illustrates an example of a general architecture of 5G.

FIG. 12 illustrates an example of a registration procedure to which the present disclosure can be applied.

FIG. 13 illustrates an embodiment of a radio radiation pattern of radio equipment to which the present disclosure can be applied.

FIG. 14 illustrates an embodiment of a method for changing a radiation pattern of a radio signal to which the present disclosure can be applied.

FIG. 15 illustrates an embodiment of the method for changing a radiation pattern of a radio signal to which the present disclosure can be applied.

FIG. 16 illustrates an embodiment of a UE to which the present disclosure can be applied.

FIG. 17 illustrates an embodiment to which the present disclosure can be applied.

FIG. 18 illustrates an embodiment of a network to which the present disclosure can be applied.

FIG. 19 illustrates a block configuration diagram of a communication device according to an embodiment of the present disclosure.

FIG. 20 illustrates a block configuration diagram of a communication device according to an embodiment of the present disclosure.

FIG. 21 illustrates a structure of a radio interface protocol in a control plane between a UE and eNodeB.

### DESCRIPTION OF EXEMPLARY EMBODIMENTS

Hereafter, various embodiments of the present disclosure will be described in detail with reference to the accompanying drawings. A detailed description to be disclosed below together with the accompanying drawing is to describe embodiments of the present disclosure and not to describe a unique embodiment for carrying out the present disclosure. The detailed description below includes details in order to provide a complete understanding. However, a person skilled in the art knows that the present disclosure can be carried out without the details.

In some cases, in order to prevent a concept of the present disclosure from being ambiguous, known structures and devices may be omitted or illustrated in a block diagram format based on core function of each structure and device.

In the present disclosure, a base station refers to a terminal node of a network directly communicating with a terminal. In some embodiments, a specific operation described as being performed by the base station may be performed by an upper node of the base station. That is, it is apparent that in the network consisting of multiple network nodes including the base station, various operations performed for communication with the terminal can be performed by the base station or network nodes other than the base station. A ‘base station (BS)’ may be generally substituted by terms such as a fixed station, Node B, evolved-NodeB (eNB), a base transceiver system (BTS), an access point (AP), and the like. Further, a ‘terminal’ may be fixed or movable and be substituted by terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink (DL) means communication from the base station to the terminal, and an uplink (UL) means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help the understanding of the present disclosure, and the specific terms may be modified into other forms within the scope without departing from the technical spirit of the present disclosure.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as Global System for Mobile communications (GSM)/General Packet Radio Service (GPRS)/Enhanced Data Rates for GSM Evolution (EDGE). The OFDMA may be implemented as radio technology such as IEEE 802.11(Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

Embodiments of the present disclosure may be supported by standard documents disclosed in at least one of IEEE 802, 3GPP, and 3GPP2 which are the wireless access systems. That is, steps or parts which are not described in embodiments of the present disclosure to definitely show the technical spirit of the present disclosure may be supported by the standard documents. Further, all terms disclosed in the present disclosure may be described in the standard documents.

3GPP LTE/LTE-A/NR is primarily described for clear description, but technical features of the present disclosure are not limited thereto.

Terms used in the present disclosure are defined as follows.

IP Multimedia Subsystem or IP Multimedia Core Network Subsystem (IMS): an architectural framework for providing standardization for delivering voice or other multimedia services on internet protocol (IP).

Universal Mobile Telecommunication System (UMTS): the 3rd generation mobile communication technology based on global system for mobile communication (GSM) developed by the 3GPP.

Evolved Packet System (EPS): a network system consisting of an evolved packet core (EPC), that is an IP based packet switched core network, and an access network such as LTE and UTRAN. The EPS is a network of an evolved version of a universal mobile telecommunications system (UMTS).

NodeB: a base station of a UMTS network. It is installed outdoor, and its coverage has a scale of a macro cell.

eNodeB: a base station of an EPS network. It is installed outdoor, and its coverage has a scale of a macro cell.

Home NodeB: it is installed indoors as a base station of the UMTS network, and its coverage has a scale of a macro cell.

Home eNodeB: it is installed indoors as a base station of the EPS network, and its coverage has a scale of a macro cell.

User Equipment (UE): the UE can be called a terminal, a mobile equipment (ME), a mobile station (MS), etc. The UE can be a portable device such as a notebook computer, a cellular phone, a personal digital assistant (PDA), a smart phone, and a multimedia device, or a fixed device such as a personal computer (PC) and a vehicle-mounted device. The term of UE may refer to an MTC UE in the description related to MTC.

Machine Type Communication (MTC): communication performed by machines without human intervention. It may be called Machine-to-Machine (M2M) communication.

MTC terminal (MTC UE or MTC device or MRT apparatus): a terminal (e.g., a vending machine, meter, etc.) having a communication function (e.g., communication with an MTC server over PLMN) over a mobile communication network and performing a MTC function.

Radio Access Network (RAN): a unit including a Node B and a radio network controller (RNC) controlling the Node B in the 3GPP network. The RAN exists at a UE end and provides a connection to a core network.

Home Location Register (HLR)/Home Subscriber Server (HSS): a database containing subscriber information within the 3GPP network. The HSS can perform functions such as configuration storage, identity management, user state storage, etc.

Public Land Mobile Network (PLMN): a network configured for the purpose of providing mobile communication services to individuals. The PLMN can be configured for each operator.

Non-Access Stratum (NAS): a functional layer for exchanging signaling and a traffic message between a UE and a core network at the UMTS and EPS protocol stacks. The NAS mainly functions to support mobility of the UE and support a session management procedure for establishing and maintaining an IP connection between the UE and PDN GW.

Service Capability Exposure Function (SCEF): an entity within the 3GPP architecture for service capability exposure that provides a means to safely expose the services and capabilities provided by 3GPP network interfaces.

Mobility Management Entity (MME): A network node in the EPS network which performs mobility management and session management functions.

Packet Data Network Gateway (PDN-GW): A network node in the EPS network which performs UE IP address allocation, packet screening and filtering, and charging data collection functions.

Serving GW (Serving Gateway): A network node in the EPS network which performs functions such as mobility anchor, packet routing, idle mode packet buffering, and triggering paging for the ME of MME.

Policy and Charging Rule Function (PCRF): A node in the EPS network which performs policy decision to dynamically apply differentiated QoS and billing policies for each service flow.

Open Mobile Alliance Device Management (OMA DM): A protocol designed to manage mobile devices, such as mobile phones, PDAs, and portable computers, which performs functions such as device configuration, firmware upgrade, and error report

Operation Administration and Maintenance (OAM): A network management function group which provides network fault indication, performance information, and data and diagnostic functions.

Packet Data Network (PDN): A network in which a server (e.g., MMS server, WAP server, etc.) supporting a specific service is located.

PDN connection: A connection from the UE to the PDN, i.e., the association (connection) between the UE represented by the IP address and the PDN represented by the APN.

EPS Mobility Management (EMM): a sublayer of the NAS layer, where the EMM may be in an “EMM-Registered” or “EMM-Deregistered” state depending on whether the UE is network attached or detached.

EMM Connection Management (ECM) connection: A signaling connection for the exchange of NAS messages, established between the UE and the MME. An ECM connection is a logical connection consisting of an RRC connection between the UE and an eNB and S1 signaling connection between the eNB and the MME. When the ECM connection is established/terminated, the RRC and S1 signaling connections are established/terminated as well. To the UE, the established ECM connection means having an RRC connection established with the eNB, and to the MME, it means having an S1 signaling connection established with the eNB. Depending on whether the NAS signaling connection, i.e., the ECM connection is established, the ECM may have an “ECM-Connected” or “ECM-Idle” state.

Access-Stratum (AS): It includes a protocol stack between the UE and the radio (or access) network and is responsible for transmitting data and network control signals.

NAS configuration Management Object (MO): A management object (MO) used to configure the UE with parameters related to NAS functionality.

Packet Data Network (PDN): A network in which a server (e.g., multimedia messaging service (MMS) server, wireless application protocol (WAP) server, etc.) supporting a specific service is located.

PDN connection: a logical connection between the UE and the PDN, represented by one IP address (one IPv4 address and/or one IPv6 prefix).

Access Point Name (APN): a string that refers to or identifies a PDN. In order to access the requested service or network, it goes through a specific P-GW, which means a predefined name (string) in the network so that the P-GW can be found. (e.g., internet.mnc012.mcc345.gprs)

Access Network Discovery and Selection Function (ANDSF): it is a network entity and provides policies that allow the UE to discover and select an available access on a per operator basis.

EPC path (or infrastructure data path): a user plane communication path through EPC.

E-UTRAN Radio Access Bearer (E-RAB): it refers to the concatenation of a S1 bearer and a corresponding data radio bearer. If there is an E-RAB, there is an one-to-one mapping between the E-RAB and the EPS bearer of the NAS.

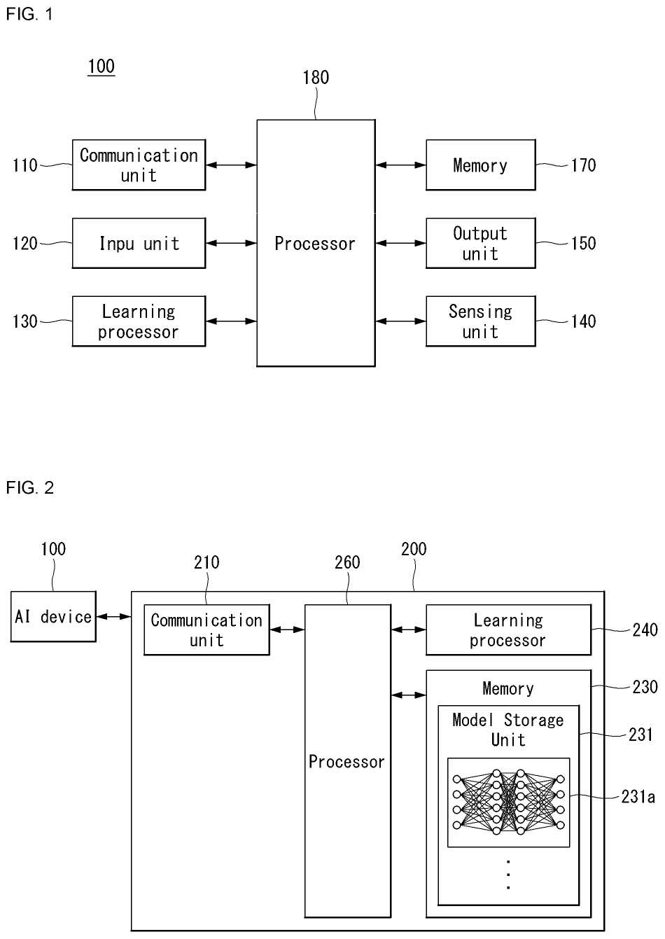

GPRS Tunneling Protocol (GTP): a group of IP-based communications protocols used to carry general packet radio service (GPRS) within GSM, UMTS and LTE networks. Within the 3GPP architecture, GTP and proxy mobile IPv6-based interfaces are specified on various interface points. GTP can be decomposed into several protocols (e.g., GTP-C, GTP-U and GTP′). GTP-C is used within a GPRS core network for signaling between gateway GPRS support nodes (GGSN) and serving GPRS support nodes (SGSN). GTP-C allows the SGSN to activate a session (e.g., PDN context activation), deactivate the same session, adjust the quality of service parameters, or renew a session for a subscriber, that has just operated from another SGSN, for the user. GTP-U is used to carry user data within the GPRS core network and between the radio access network and the core network. FIG. 1 illustrates a schematic structure of an evolved packet system (EPS) including an evolved packet core (EPC).

Cell as a radio resource: the 3GPP LTE/LTE-A system has used a concept of a cell to manage radio resources, and a cell related to the radio resource is distinguished from a cell of a geographic area. The “cell” related to the radio resource is defined as a combination of downlink (DL) resources and uplink (UL) resources, i.e., a combination of DL carriers and UL carriers. The cell may be configured with DL resource only or a combination of DL resources and UL resources. If carrier aggregation is supported, a linkage between a carrier frequency of the DL resource and a carrier frequency of the UL resource may be indicated by system information. Here, the carrier frequency refers to a center frequency of each cell or carrier. In particular, a cell operating on a primary frequency is called a primary cell or Pcell, and a cell operating on a secondary frequency is called a secondary cell or Scell. The Scell refers to a cell that can be configured after radio resource control (RRC) connection establishment is achieved and can be used for providing additional radio resources. Depending on capabilities of the UE, the Scell together with the Pcell can form a set of serving cells for the UE. For the UE that is in a RRC_CONNECTED state but is not configured with carrier aggregation, or does not support carrier aggregation, there is only one serving cell configured with only the Pcell. The “cell’ of the geographic area can be understood as a coverage in which a node can provide services using a carrier, and the “cell’ of the radio resource is related to a bandwidth (BW) that is a frequency range configured by the carrier. Since a downlink coverage that is a range within which the node can transmit a valid signal and an uplink coverage that is a range within which the node can receive the valid signal from the UE depend on the carrier carrying the corresponding signal, the coverage of the node is associated with the coverage of the “cell’ of the radio resource the node uses. Thus, the term “cell” may be used to sometimes denote the coverage of the service by the node, sometimes denote the radio resource, and sometimes denote a range that a signal using the radio resources can reach with a valid strength.

The EPC is a key element of system architecture evolution (SAE) to improve the performance of 3GPP technologies. The SAE corresponds to a research project to determine a network structure supporting mobility between various kinds of networks. The SAE aims to provide an optimized packet-based system, for example, supporting various radio access technologies on an IP basis and providing more improved data transfer capability.

More specifically, the EPC is a core network of an IP mobile communication system for the 3GPP LTE system and can support packet-based real-time and non-real time services. In the existing mobile communication system (i.e., in the 2nd or 3rd mobile communication system), functions of the core network have been implemented through two separate sub-domains including a circuit-switched (CS) sub-domain for voice and a packet-switched (PS) sub-domain for data. However, in the 3GPP LTE system that is an evolution of the 3rd mobile communication system, the CS and PS sub-domains have been unified into a single IP domain. That is, in the 3GPP LTE system, a connection between UEs having IP capabilities can be configured via an IP-based base station (e.g., evolved Node B (eNodeB)), an EPC, and an application domain (e.g., IP multimedia subsystem (IMS)). In other words, the EPC is an essential architecture to implement end-to-end IP services.

The EPC may include various components, and FIG. 1 illustrates some of the EPC components, including a serving gateway (SGW), a packet data network gateway (PDN GW), a mobility management entity (MME), a SGSN (serving GPRS (general packet radio service) supporting node), and an enhanced packet data gateway (ePDG).

The SGW (or S-GW) operates as a boundary point between a radio access network (RAN) and a core network, and is an element that functions to maintain a data path between the eNB and the PDN GW. Further, if the UE moves across areas served by the eNB, the SGW serves as a local mobility anchor point. That is, packets can be routed through the SGW for mobility within the E-UTRAN (evolved-universal mobile telecommunications system (UMTS) terrestrial radio access network defined in 3GPP Release-8 or later). The SGW may also serve as an anchor point for mobility with other 3GPP networks (RAN defined before 3GPP Release-8, for example, UTRAN or GERAN (global system for mobile communication (GSM)/enhanced data rates for global evolution (EDGE) radio access network).

The PDN GW (or P-GW) corresponds to a termination point of a data interface to a packet data network. The PDN GW can support policy enforcement features, packet filtering, charging support, and the like. In addition, the PDN GW can serve as an anchor point for mobility management between the 3GPP network and a non-3GPP network (e.g., untrusted networks such as an interworking wireless local area network (I-WLAN) or trusted networks such as a code division multiple access (CDMA) network and Wimax).

Hereinafter, the present disclosure is described based on the terms defined as above.

Three major requirement areas of 5G include (1) an enhanced mobile broadband (eMBB) area, (2) a massive machine type communication (mMTC) area, and (3) an ultra-reliable and low latency communications (URLLC) area.

Some use cases may require multiple areas for optimization, and other use case may be focused on only one key performance indicator (KPI). 5G supports these various use cases in a flexible and reliable method.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this can be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link with ultra reliability/low available latency, such as a self-driving vehicle. A level of reliability and latency is essential for smart grid control, industry automation, robot engineering, drone control and adjustment.

Multiple use cases are described in more detail below.

5G can supplement fiber-to-the-home (FTTH) and cable-based broadband (or DOCSIS) as means for providing a stream evaluated from several hundreds of mega bits per second to gigabits per second. Such fast speed is required to deliver TV with a resolution of 4K or more (6K, 8K or more) in addition to virtual reality and augmented reality. Virtual reality (VR) and augmented reality (AR) applications include immersive sports games. A specific application program may require a special network configuration. For example, for VR games, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between vehicles, information exchange between a vehicle and a supported infrastructure, and information exchange between a vehicle and other connected devices (e.g., devices accompanied by a pedestrian). A safety system guides alternative courses of a behavior so that a driver can drive more safely, thereby reducing a danger of an accident. A next stage will be a remotely controlled or self-driven vehicle. This requires very reliable, very fast communication between different self-driven vehicles and between an automotive and infra. In the future, a self-driving vehicle can perform all driving activities, and a driver will be focused on only abnormal traffics, which cannot be identified by a vehicle itself. Technical requirements of a self-driving vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system can support remote treatment providing clinical treatment at a distant place. This helps to reduce a barrier for the distance and can improve access to medical services which are not continuously used at remote farming areas. Furthermore, this is used to save life in important treatment and an emergency condition. A radio sensor network based on mobile communication can provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

Embodiments of the present disclosure to be described below can be implemented through the combination or the modification in order to meet the 5G requirements described above.

The following is described in detail in relation to the technical field to which embodiments of the present disclosure to be described below can be applied.

Artificial Intelligence (AI)

Artificial intelligence means the field in which artificial intelligence or methodology capable of producing artificial intelligence is researched. Machine learning means the field in which various problems handled in the artificial intelligence field are defined and methodology for solving the problems are researched. Machine learning is also defined as an algorithm for improving performance of a task through continuous experiences for the task.

An artificial neural network (ANN) is a model used in machine learning, and is configured with artificial neurons (nodes) forming a network through a combination of synapses, and may mean the entire model having a problem-solving ability. The artificial neural network may be defined by a connection pattern between the neurons of different layers, a learning process of updating a model parameter, and an activation function for generating an output value.

The artificial neural network may include an input layer, an output layer, and optionally one or more hidden layers. Each layer includes one or more neurons. The artificial neural network may include a synapse connecting neurons. In the artificial neural network, each neuron may output a function value of an activation function for input signals, weight, and a bias input through a synapse.

A model parameter means a parameter determined through learning, and includes the weight of a synapse connection and the bias of a neuron. Furthermore, a hyper parameter means a parameter that needs to be configured prior to learning in the machine learning algorithm, and includes a learning rate, the number of times of repetitions, a mini-deployment size, and an initialization function.

The purpose of learning of the artificial neural network may be considered to determine a model parameter that minimizes a loss function. The loss function may be used as an index for determining an optimal model parameter in the learning process of an artificial neural network.

Machine learning may be classified into supervised learning, unsupervised learning, and reinforcement learning based on a learning method.

Supervised learning means a method of training an artificial neural network in the state in which a label for learning data has been given. The label may mean an answer (or a result value) that must be deduced by an artificial neural network when learning data is input to the artificial neural network. Unsupervised learning may mean a method of training an artificial neural network in the state in which a label for learning data has not been given. Reinforcement learning may mean a learning method in which an agent defined within an environment is trained to select a behavior or behavior sequence that maximizes accumulated compensation in each state.

Machine learning implemented as a deep neural network (DNN) including a plurality of hidden layers, among artificial neural networks, is also called deep learning. Deep learning is part of machine learning. Hereinafter, machine learning is used as a meaning including deep learning.

Robot

A robot may mean a machine that automatically processes a given task or operates based on an autonomously owned ability. Particularly, a robot having a function for recognizing an environment and autonomously determining and performing an operation may be called an intelligent robot.

A robot may be classified for industry, medical treatment, home, and military based on its use purpose or field.

A robot includes a driver including an actuator or motor, and can perform various physical operations, such as moving a robot joint. Furthermore, a movable robot includes a wheel, a brake, a propeller, etc. in a driver, and may run on the ground or fly in the air through the driver.

Self-Driving (Autonomous-Driving)

Self-driving means a technology for autonomous driving. A self-driving vehicle means a vehicle that runs without user manipulation or by user's minimum manipulation.

For example, self-driving may include all of a technology for maintaining a driving lane, a technology for automatically controlling speed, such as adaptive cruise control, a technology for automatically driving along a fixed path, a technology for automatically setting a path when a destination is set and driving, and the like.

A vehicle includes all of a vehicle having only an internal combustion engine, a hybrid vehicle including both an internal combustion engine and an electric motor, and an electric vehicle having only an electric motor, and may include a train, a motorcycle, etc. in addition to the vehicles.

In this case, the self-driving vehicle may be considered as a robot having a self-driving function.

Extended Reality (XR)

Extended reality collectively refers to virtual reality (VR), augmented reality (AR), and mixed reality (MR). The VR technology provides an object or background of the real world as a CG image only. The AR technology provides a virtually produced CG image on an actual thing image. The MR technology is a computer graphics technology for mixing and combining virtual objects with the real world and providing them.

The MR technology is similar to the AR technology in that it shows a real object and a virtual object. However, in the AR technology, a virtual object is used to supplement a real object. In contrast, unlike in the AR technology, in the MR technology, a virtual object and a real object are used as the same character.

The XR technology can be applied to a head-mount display (HMD), a head-up display (HUD), a mobile phone, a tablet PC, a laptop, a desktop, TV, a digital signage, and the like. A device to which the XR technology is applied may be called an XR device.

FIG. 1 illustrates an AI device 100 according to an embodiment of the present disclosure.

The AI device 100 may be implemented as a fixed device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, a digital signage, a robot, and a vehicle.

Referring to FIG. 1, the terminal 100 may include a communication unit 110, an input unit 120, a learning processor 130, a sensing unit 140, an output unit 150, a memory 170, and a processor 180.

The communication unit 110 may transmit and receive data to and from external devices, such as other AI devices 100a to 100er or an AI server 200, using wired and wireless communication technologies. For example, the communication unit 110 may transmit and receive sensor information, a user input, a learning model, and a control signal to and from external devices.

Examples of communication technologies used by the communication unit 110 include a global system for mobile communication (GSM), code division multi access (CDMA), long term evolution (LTE), ‘5G, a wireless LAN (WLAN), wireless-fidelity (Wi-Fi), Bluetooth™, radio frequency identification (RFID), infrared data association (IrDA), ZigBee, near field communication (NFC), etc.

The input unit 120 may obtain various types of data.

The input unit 120 may include a camera for an image signal input, a microphone for receiving an audio signal, a user input unit for receiving information from a user, etc. Herein, the camera or the microphone is treated as a sensor, and a signal obtained from the camera or the microphone may be called sensing data or sensor information.

The input unit 120 can obtain learning data for model learning and input data to be used when an output is obtained using a learning model. The input unit 120 can obtain not-processed input data. In this case, the processor 180 or the learning processor 130 can extract an input feature by performing pre-processing on the input data.

The learning processor 130 may be trained by a model configured with an artificial neural network using learning data. In this case, the trained artificial neural network may be called a learning model. The learning model may be used to deduce a result value of new input data not learning data, and the deduced value may be used as a base for performing a given operation.

The learning processor 130 can perform AI processing along with the learning processor 240 of the AI server 200.

The learning processor 130 may include a memory integrated or implemented in the AI device 100. Alternatively, the learning processor 130 may be implemented using the memory 170, an external memory directly coupled to the AI device 100, or a memory maintained in an external device.

The sensing unit 140 can obtain at least one of internal information of the AI device 100, surrounding environment information of the AI device 100, or user information using various sensors.

Examples of sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, LIDAR, and a radar, etc.

The output unit 150 can generate an output related to a visual sense, an auditory sense or a tactile sense.

The output unit 150 may include a display for outputting visual information, a speaker for outputting auditory information, and a haptic module for outputting tactile information.

The memory 170 can store data supporting various functions of the AI device 100. For example, the memory 170 can store input data obtained by the input unit 120, learning data, a learning model, a learning history, etc.

The processor 180 can determine at least one executable operation of the AI device 100 based on information that is determined or generated using a data analysis algorithm or a machine learning algorithm. Furthermore, the processor 180 can perform the determined operation by controlling the components of the AI device 100.

To this end, the processor 180 can request, search, receive, and use data of the learning processor 130 or the memory 170, and can control the components of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 can obtain intention information for a user input and transmit user requirements based on the obtained intention information.

The processor 180 can obtain the intention information, corresponding to the user input, using at least one of a speech to text (STT) engine for converting a voice input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 18 may control at least some of the components of the AI device 100 in order to execute an application program stored in the memory 170. Moreover, the processor 180 may combine and operate two or more of the components included in the AI device 100 in order to execute the application program.

FIG. 2 illustrates an AI server 200 according to an embodiment of the present disclosure.

Referring to FIG. 2, the AI server 200 may mean a device which is trained by an artificial neural network using a machine learning algorithm or which uses a trained artificial neural network. Herein, the AI server 200 consists of a plurality of servers and may perform distributed processing and may be defined as a 5G network. Further, the AI server 200 may be included as a partial configuration of the AI device 100 and may perform at least some of AI processing.

The AI server 200 may include a communication unit 210, a memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If a part or all of the learning model is implemented as software, one or more instructions configuring the learning model may be stored in the memory 230.

The processor 260 may deduce a result value of new input data using the learning model, and may generate a response or control command based on the deduced result value.

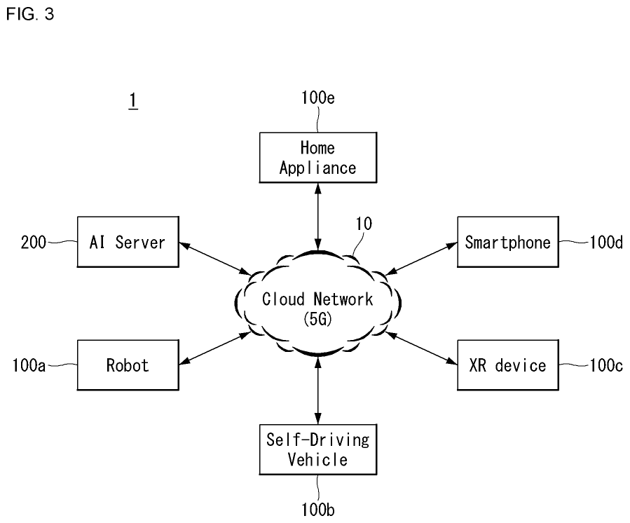

FIG. 3 illustrates an AI system 1 according to an embodiment of the present disclosure.

Referring to FIG. 3, the AI system 1 is connected to at least one of the AI server 200, a robot 100a, a self-driving vehicle 100b, an XR device 100c, a smartphone 100d or home appliances 100e over a cloud network 10. In this case, the robot 100a, the self-driving vehicle 100b, the XR device 100c, the smartphone 100d or the home appliances 100e to which the AI technology is applied may be called AI devices 100a to 100e.

The cloud network 10 may constitute part of cloud computing infra or may mean a network present within cloud computing infra. Here, the cloud network 10 may be configured using the 3G network, the 4G or long term evolution (LTE) network or the 5G network.

That is, the devices 100a to 100e and 200 constituting the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100d or the home appliances 100e, that are AI devices constituting the AI system 1, over the cloud network 10, and may help at least some of the AI processing of the connected AI devices 100a to 100e.

The AI server 200 can train an artificial neural network based on a machine learning algorithm in place of the AI devices 100a to 100e, and can directly store a learning model or transmit the learning model to the AI devices 100a to 100e.

The AI server 200 can receive input data from the AI devices 100a to 100e, deduce a result value of the received input data using the learning model, generate a response or control command based on the deduced result value, and transmit the response or control command to the AI devices 100a to 100e.

Alternatively, the AI devices 100a to 100e can directly deduce a result value of input data using a learning model, and can generate a response or control command based on the deduced result value.

Various implementations of the AI devices 100a to 100e to which the above-described technologies are applied are described below. Herein, the AI devices 100a to 100e illustrated in FIG. 3 may be considered to be detailed implementations of the AI device 100 illustrated in FIG. 1.

AI and Robot to which the Present Disclosure is Applicable

An AI technology is applied to the robot 100a, and the robot 100a may be implemented as a guidance robot, a transport robot, a cleaning robot, a wearable robot, an entertainment robot, a pet robot, an unmanned aerial robot, etc.

The robot 100a may include a robot control module for controlling an operation. The robot control module may mean a software module or a chip in which a software module is implemented using hardware.

The robot 100a may obtain state information of the robot 100a, detect (recognize) a surrounding environment and an object, generate map data, determine a moving path and a running plan, determine a response to a user interaction, or determine an operation, using sensor information obtained from various types of sensors.

The robot 100a may use sensor information obtained by at least one sensor among LIDAR, a radar, and a camera in order to determine the moving path and the running plan.

The robot 100a may perform the above operations using a learning model consisting of at least one artificial neural network. For example, the robot 100a may recognize a surrounding environment and an object using the learning model, and determine an operation using the recognized surrounding environment information or object information. Here, the learning model may have been directly trained in the robot 100a or may have been trained in an external device, such as the AI server 200.

The robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driving unit.

The map data may include object identification information for various objects disposed in the space in which the robot 100a moves. For example, the map data may include object identification information for fixed objects, such as a wall and a door, and movable objects, such as a flowerport and a desk. Furthermore, the object identification information may include a name, a type, a distance, a location, etc.

Furthermore, the robot 100a may perform an operation or run by controlling the driving unit based on a user's control/interaction. In this case, the robot 100a may obtain intention information of an interaction according to a user's behavior or voice speaking, may determine a response based on the obtained intention information, and may perform an operation.

AI and Self-Driving to which the Present Disclosure is Applicable

An AI technology is applied to the self-driving vehicle 100b, and the self-driving vehicle 100b may be implemented as a mobile robot, a vehicle, an unmanned aerial vehicle, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as the component of the self-driving vehicle 100b, but may be configured as separate hardware outside the self-driving vehicle 100b and connected to the self-driving vehicle 100b.

The self-driving vehicle 100b may obtain state information of the self-driving vehicle 100b, detect (recognize) a surrounding environment and object, generate map data, determine a moving path and a running plan, or determine an operation, using sensor information obtained from various types of sensors.

In order to determine the moving path and the running plan, the self-driving vehicle 100b may use sensor information obtained from at least one sensor among LIDAR, a radar and a camera, in the same manner as the robot 100a.

Particularly, the self-driving vehicle 100b may recognize an environment or an object in an area in which a sight is blocked or an area of a predetermined distance or more by receiving sensor information about the environment or the object from external devices, or may receive information about the environment or object that is directly recognized from the external devices.

The self-driving vehicle 100b may perform the above operations using a learning model consisting of at least one artificial neural network. For example, the self-driving vehicle 100b may recognize a surrounding environment and object using a learning model and determine the flow of running using recognized surrounding environment information or object information. In this case, the learning model may have been directly trained in the self-driving vehicle 100b or may have been trained in an external device, such as the AI server 200.

In this case, the self-driving vehicle 100b may directly generate results using the learning model to perform an operation, but may perform an operation by transmitting sensor information to an external device, such as the AI server 200, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driver.

The map data may include object identification information for various objects disposed in the space (e.g., road) on which the self-driving vehicle 100b runs. For example, the map data may include object identification information for fixed objects, such as a streetlight, a rock, and a building, etc., and mobile objects, such as a vehicle and a pedestrian. Furthermore, the object identification information may include a name, a type, a distance, a location, etc.

Furthermore, the self-driving vehicle 100b may perform an operation or run by controlling the driving unit based on a user's control/interaction. In this case, the self-driving vehicle 100b may obtain intention information of an interaction according to a user' behavior or voice speaking, may determine a response based on the obtained intention information, and may perform an operation.

AI and XR to which the Present Disclosure is Applicable

An AI technology is applied to the XR device 100c, and the XR device 100c may be implemented as a head-mount display (HMD), a head-up display (HUD) provided in a vehicle, television, a mobile phone, a smartphone, a computer, a wearable device, home appliances, a digital signage, a vehicle, a fixed robot or a mobile robot.

The XR device 100c may generate location data and attributes data for three-dimensional points by analyzing three-dimensional point cloud data or image data obtained through various sensors or from an external device, may obtain information on a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

AI, Robot and Self-Driving to which the Present Disclosure is Applicable

An AI technology and a self-driving technology are applied to the robot 100a, and the robot 100a may be implemented as a guidance robot, a transport robot, a cleaning robot, a wearable robot, an entertainment robot, a pet robot, an unmanned aerial robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously move along a given flow without control of a user or autonomously determine a flow and move.

The robot 100a and the self-driving vehicle 100b having the self-driving function may use a common sensing technique in order to determine one or more of a moving path or a running plan. For example, the robot 100a and the self-driving vehicle 100b having the self-driving function may determine one or more of a moving path or a running plan using information sensed through LIDAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driving unit of the self-driving vehicle 100b. In this case, the function of the self-driving vehicle 100b controlled by the robot 100a may include a function provided by a navigation system or audio system provided within the self-driving vehicle 100b, in addition to a self-driving function simply.

Alternatively, the robot 100a interacting with the self-driving vehicle 100b may provide information to the self-driving vehicle 100b or may assist a function outside the self-driving vehicle 100b. For example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

AI, Robot and XR to which the Present Disclosure is Applicable

An AI technology and an XR technology are applied to the robot 100a, and the robot 100a may be implemented as a guidance robot, a transport robot, a cleaning robot, a wearable robot, an entertainment robot, a pet robot, an unmanned aerial robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

AI, Self-Driving and XR to which the Present Disclosure is Applicable

An AI technology and an XR technology are applied to the self-driving vehicle 100b, and the self-driving vehicle 100b may be implemented as a mobile robot, a vehicle, an unmanned aerial vehicle, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

If the self-driving vehicle 100b that is a target of control/interaction within an XR image obtains sensor information from sensors including a camera, the self-driving vehicle 100b or the XR device 100c may create an XR image based on the sensor information, and the XR device 100c may output the created XR image. Furthermore, the self-driving vehicle 100b may operate based on a control signal received through an external device, such as the XR device 100c, or a user's interaction.

5G System Architecture to which the Present Disclosure is Applicable

A 5G system is an advanced technology from 4G LTE mobile communication technology and supports a new radio access technology (RAT), extended long term evolution (eLTE) as an extended technology of LTE, non-3GPP access (e.g., wireless local area network (WLAN) access), etc. through the evolution of the existing mobile communication network structure or a clean-state structure.

The 5G system is defined based on a service, and an interaction between network functions (NFs) in an architecture for the 5G system can be represented in two ways as follows.

Reference point representation: indicates an interaction between NF services in NFs described by a point-to-point reference point (e.g., N11) between two NFs (e.g., AMF and SMF).

Service-based representation: network functions (e.g., AMF) within a control plane (CP) allow other authenticated network functions to access its services. The representation also includes a point-to-point reference point, if necessary.

Overview of 3GPP System

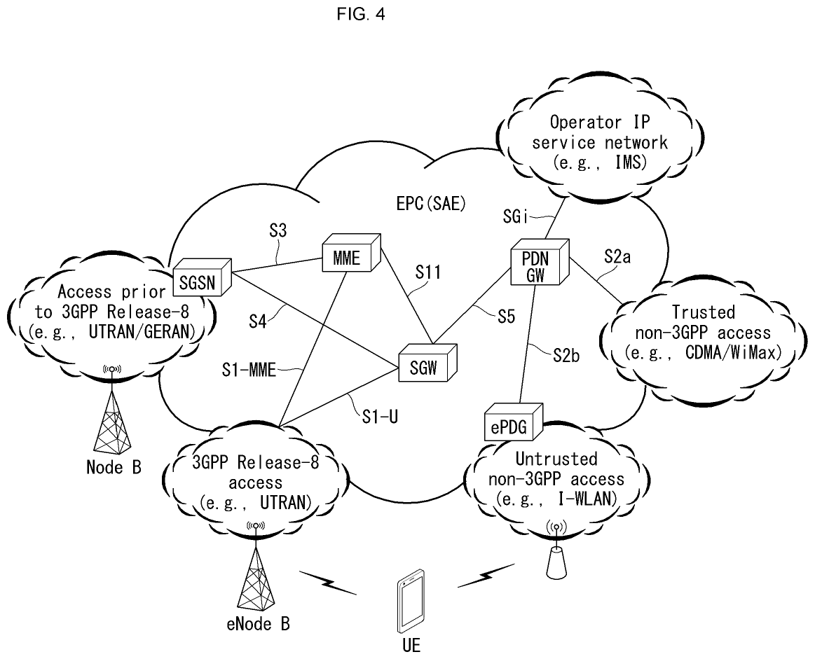

FIG. 4 illustrates various reference points.

In an example of a network structure illustrated in FIG. 4, the SGW and the PDN GW are configured as separate gateways, but the two gateways may be implemented according to a single gateway configuration option.

The MME is an element to perform signaling and control functions for supporting access to the network connection of the UE, allocation, tracking, paging, roaming, and handover of network resources, and so on. The MME controls control plane functions related to subscribers and session management. The MME manages a large number of eNBs and performs signaling of the conventional gateway selection for handover to other 2G/3G networks. Further, the MME performs functions such as security procedures, terminal-to-network session handling, idle terminal location management, and so on.

The SGSN handles all packet data such as mobility management and authentication of the user for another 3GPP network (e.g., GPRS network).

The ePDG serves as a security node for an untrusted non-3GPP network (e.g., I-WLAN, Wi-Fi hotspot, etc.)

As described with reference to FIG. 4, the UE with IP capability can access the IP service network (e.g., IMS) provided by a service provider (i.e., operator) via various components within the EPC based on the non-3GPP access as well as the 3GPP access.

For example, reference points such as S1-U and S1-MME can connect two functions present in different functional entities. The 3GPP system defines a conceptual link connecting two functions present in different functional entities of E-UTRAN and EPC, as a reference point. The following Table 1 summarizes reference points illustrated in FIG. 4. In addition to the example of Table 1, various reference points can exist depending on the network structure.

TABLE 1

| Reference Point | Description |
|---|---|
| S1-MME | Reference point for the control plane protocol between E-UTRAN and |
| | MME |
| Sl-U | Reference point between E-UTRAN and Serving GW for the per |
| | bearer user plane tunneling and inter eNodeB path switching during |
| | handover |
| S3 | It enables user and bearer information exchange for inter 3GPP access |
| | network mobility in idle and/or active state. This reference point can |
| | be used intra-PLMN or inter-PLMN (e.g. in the case of Inter-PLMN |
| | HO). |
| S4 | It provides related control and mobility support between GPRS Core |
| | and the 3GPP Anchor function of Serving GW. In addition, if Direct |
| | Tunnel is not established, it provides the user plane tunneling. |
| S5 | It provides user plane tunneling and tunnel management between |
| | Serving GW and PDN GW. It is used for Serving GW relocation due |
| | to UE mobility and if the Serving GW needs to connect to a non- |
| | collocated PDN GW for the required PDN connectivity. |
| S11 | Reference point for the control plane protocol between MME and |
| | SGW |
| SGi | It is the reference point between the PDN GW and the packet data |
| | network. Packet data network may be an operator external public or |
| | private packet data network or an intra operator packet data network, |
| | e.g. for provision of IMS services. This reference point corresponds to |
| | Gi for 3GPP accesses. |

Among the reference points illustrated in FIG. 4, S2a and S2b correspond to non-3GPP interfaces. S2a is a reference point to provide a user plane with related control and mobility support between the trusted non-3GPP access and the PDN GW. S2b is a reference point to provide a user plane with related control and mobility support between the ePDG and the PDN GW.

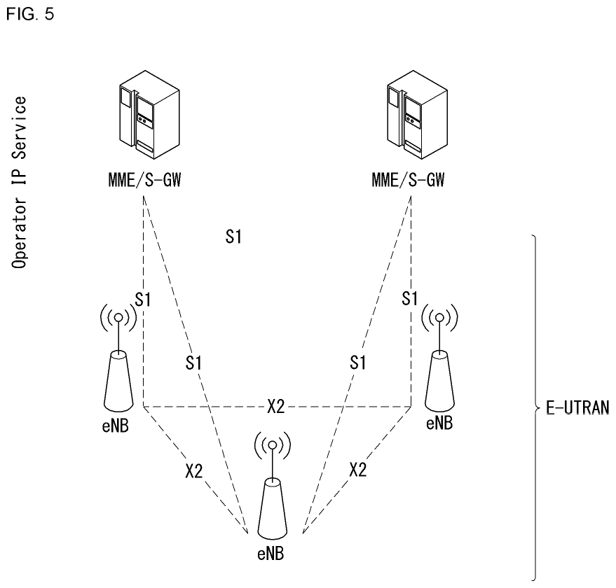

FIG. 5 illustrates an example of a network structure of an evolved universal terrestrial radio access network (E-UTRAN) to which the present disclosure is applicable.

An E-UTRAN system is an evolved version of the existing UTRAN system and may be, for example, 3GPP LTE/LTE-A system. Communication networks are widely deployed to provide various communication services such as voice (e.g., voice over Internet protocol (VoIP)) through IMS and packet data.

Referring to FIG. 5, an E-UMTS network includes an E-UTRAN, an EPC, and one or more UEs. The E-UTRAN consists of eNBs that provide control plane and user plane protocols to the UE, and the eNBs are interconnected with each other by means of the X2 interface.

X2 user plane (X2-U) interface is defined between the eNBs. The X2-U interface provides non-guaranteed delivery of a user plane packet data unit (PDU). X2 control plane (X2-CP) interface is defined between two neighboring eNBs. The X2-CP performs functions of context delivery between the eNBs, control of user plane tunnel between a source eNB and a target eNB, delivery of handover-related messages, uplink load management, and the like.

The eNB is connected to the UE via a radio interface and is connected to an evolved packet core (EPC) by means of the S1 interface.

S1 user plane (S1-U) interface is defined between the eNB and a serving gateway (S-GW). S1 control plane interface (S1-MME) is defined between the eNB and a mobility management entity (MME). The S1 interface performs functions of evolved packet system (EPS) bearer service management, non-access stratum (NAS) signaling transport, network sharing, MME load balancing, and so on. The S1 interface supports many-to-many-relation between the eNB and the MME/S-GW.

The MME can perform various functions such as NAS signaling security, access stratum (AS) security control, inter-core network (CN) node signaling for supporting mobility between 3GPP access networks, idle mode UE reachability (including control and execution of paging retransmission), tracking area identity (TAI) management (for UE in idle and active modes), PDN GW and SGW selection, MME selection for handover with MME change, SGSN selection for handover to 2G or 3G 3GPP access networks, roaming, authentication, bearer management functions including dedicated bearer establishment, support of public warning system (PWS) (including earthquake and tsunami warning system (ETWS) and commercial mobile alert system (CMAS)) message transmission, and the like.

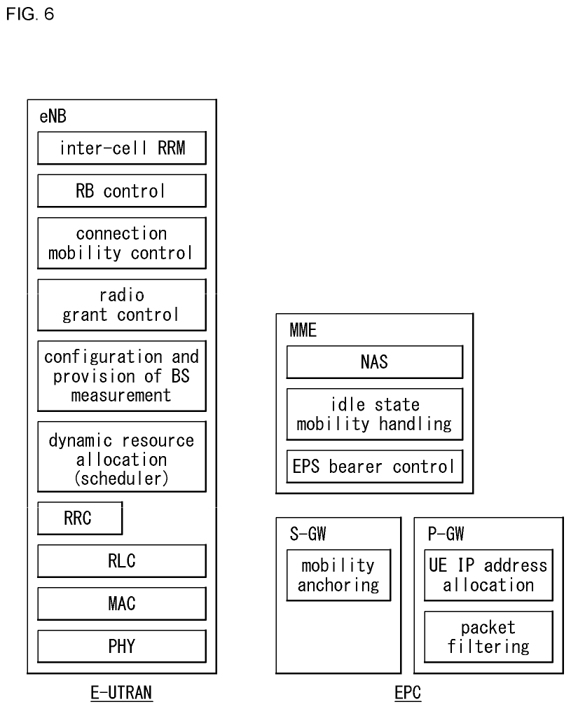

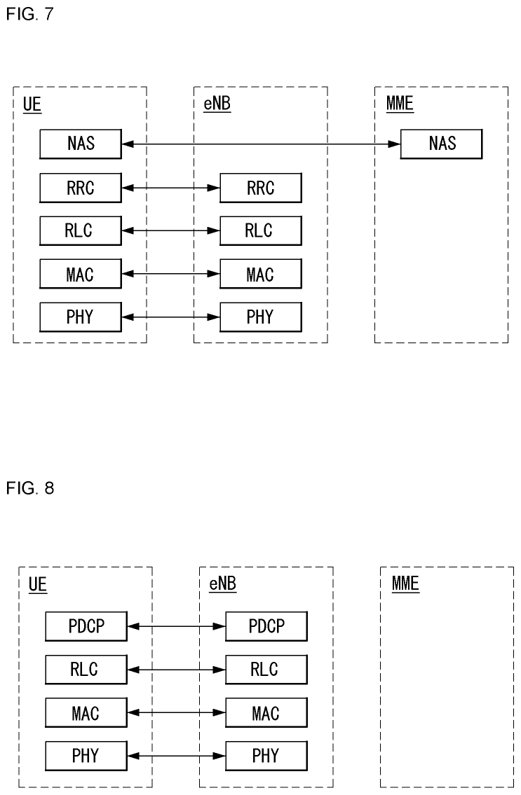

FIG. 6 illustrates an example of a general architecture of E-UTRAN and EPC.

As illustrated in FIG. 6, the eNB can perform functions such as routing to gateway while radio resource control (RRC) connection is activated, scheduling and transmission of paging messages, scheduling and transmission of a broadcast channel (BCH), dynamic allocation of resources in uplink and downlink to the UE, configuration and provision for the measurement of the eNB, radio bearer control, radio admission control, and connection mobility control. The eNB can perform functions such as paging generation in the EPC, management of an LTE_IDLE state, ciphering of a user plane, SAE bearer control, and ciphering and integrity protection of NAS signaling.

Annex J of 3GPP TR 23.799 shows various architectures by combining 5G and 4G. An architecture using NR and NGC is disclosed in 3GPP TS 23.501.

FIG. 7 illustrates an example of a structure of a radio interface protocol in a control plane between a UE and eNB. FIG. 8 illustrates an example of a structure of a radio interface protocol in a user plane between a UE and eNB.

The radio interface protocol is based on 3GPP radio access network standard. The radio interface protocol horizontally consists of a physical layer, a data link layer, and a network layer, and is vertically divided into a user plane for data information transmission and a control plane for control signaling delivery.

The protocol layers may be divided into L1 (first layer), L2 (second layer), and L3 (third layer) based upon three lower layers of an open system interconnection (OSI) standard model that is well known in the art of communication systems.

The layers of the radio protocol in the control plane illustrated in FIG. 7 and the layers of the radio protocol in the user plane illustrated in FIG. 8 are described below.

The physical layer, the first layer, provides an information transfer service using a physical channel. The physical layer is connected with a medium access control (MAC) layer located at a higher level via a transport channel, and data between the MAC layer and the physical layer is transferred via the transport channel. Data is transferred between different physical layers, i.e., between physical layers of a transmission side and a reception side via the physical channel.

The physical channel consists of several subframes on a time axis and several subcarriers on a frequency axis. Here, one subframe consists of a plurality of OFDM symbols and a plurality of subcarriers on the time axis. One subframe consists of a plurality of resource blocks, and one resource block consists of a plurality of OFDM symbols and a plurality of subcarriers. A unit time, a transmission time interval (TTI), at which data is transmitted is 1 ms corresponding to one subframe.

Physical channels existing in the physical layers of the transmission side and the reception side may be divided into a physical downlink shared channel (PDSCH) and a physical uplink shared channel (PUSCH) that are data channels, and a physical downlink control channel (PDCCH), a physical control format indicator channel (PCFICH), a physical hybrid-ARQ indicator channel (PHICH), and a physical uplink control channel (PUCCH) that are control channels, according to 3GPP LTE.

There are several layers in the second layer. A medium access control (MAC) layer of the second layer functions to map various logical channels to various transfer channels, and also performs a function of logical channel multiplexing for mapping several logical channels to one transfer channel. The MAC layer is connected to a radio link control (RLC) layer, that is an upper layer, via the logical channel. The logical channel is roughly divided into a control channel used to transmit information of the control plane and a traffic channel used to transmit information of the user plane according to a type of transmitted information.

The MAC layer of the second layer segments and concatenate data received from the upper layer and adjusts a data size so that a lower layer is adapted to transmit data to a radio section.

A packet data convergence protocol (PDCP) layer of the second layer performs a header compression function of reducing an IP packet header size that has a relatively large size and contains unnecessary control information, in order to efficiently transmit data in a radio section having a small bandwidth upon transmission of IP packet such as IPv4 or IPv6. In addition, in the LTE system, the PDCP layer also performs a security function, which consists of ciphering for preventing data interception by a third party and integrity protection for preventing data manipulation by a third party.

A radio resource control (RRC) layer located at the uppermost part of the third layer is defined only in the control plane and is responsible for controlling logical channels, transport channels, and physical channels in relation to configuration, re-configuration, and release of radio bearers (RBs). The RB means services provided by the second layer to ensure data transfer between the UE and the E-UTRAN.

If an RRC connection is established between an RRC layer of the UE and an RRC layer of a wireless network, the UE is in an RRC connected mode. Otherwise, the UE is in an RRC idle mode.

An RRC state of the UE and an RRC connection method are described below. The RRC state refers to a state in which the RRC of the UE is or is not logically connected with the RRC of the E-UTRAN. The RRC state of the UE having logical connection with the RRC of the E-UTRAN is referred to as an RRC_CONNECTED state, and the RRC state of the UE not having logical connection with the RRC of the E-UTRAN is referred to as an RRC IDLE state. Since the UE in the RRC_CONNECTED state has the RRC connection, the E-UTRAN can identify the presence of the corresponding UE on a per cell basis and thus efficiently control the UE. On the other hand, the E-UTRAN cannot identify the presence of the UE of the RRC_IDLE state, and the UE in the RRC_IDLE state is managed by a core network based on a tracking area (TA) which is an area unit larger than the cell. That is, for the UE in the RRC_IDLE state, only presence or absence of the corresponding UE is identified in an area unit larger than the cell. In order for the UE of the RRC_IDLE state to receive typical mobile communication services such as voice and data, the UE should transition to the RRC_CONNECTED state. Each TA is distinguished from another TA by a tracking area identity (TAI) thereof. The UE may configure the TAI through a tracking area code (TAC) which is information broadcasted from a cell.

When the user initially turns on the UE, the UE first searches for a proper cell, and then establishes RRC connection in the corresponding cell and registers information of the UE in the core network. Thereafter, the UE stays in the RRC_IDLE state. The UE staying in the RRC_IDLE state (re)selects a cell and checks system information or paging information, if necessary. This operation is called camping on a cell. Only when the UE staying in the RRC_IDLE state needs to establish the RRC connection, the UE establishes the RRC connection with the RRC layer of the E-UTRAN through a RRC connection procedure and transitions to the RRC_CONNECTED state. There are several cases where the UE remaining in the RRC_IDLE state needs to establish the RRC connection. For example, the cases may include an attempt of a user to make a phone call, an attempt to transmit data, or transmission of a response message when receiving a paging message from the E-UTRAN.

A non-access stratum (NAS) layer positioned over the RRC layer performs functions such as session management and mobility management.

The NAS layer shown in FIG. 7 is described in detail below.

The evolved session management (ESM) belonging to the NAS layer performs functions such as default bearer management and dedicated bearer management to control the UE to use a PS service from a network. The default bearer resources are allocated from a network when they are accessed to the network upon first access to a specific packet data network (PDN). In this instance, the network allocates an IP address available for the UE so that the UE can use a data service, and also allocates QoS of a default bearer. LTE roughly supports two types of bearers including a bearer with guaranteed bit rate (GBR) QoS characteristics for guaranteeing a specific bandwidth for data transmission/reception and a non-GBR bearer with best effort QoS characteristics without guaranteeing a bandwidth. The default bearer is allocated the non-GBR bearer. The dedicated bearer may be allocated a bearer with GBR or non-GBR QoS characteristics.

A bearer that the network allocates to the UE is referred to as an evolved packet service (EPS) bearer. When the network allocates the EPS bearer to the UE, the network assigns one ID. This ID is called an EPS bearer ID. One EPS bearer has QoS characteristics of a maximum bit rate (MBR) and/or a guaranteed bit rate (GBR).

UE's Network Selection Procedure

A UE being camped on a cell is described in detail as follow.

If the UE is switched on or intends to newly access a cell, the UE performs an initial cell search procedure including, for example, obtaining time and frequency synchronizations with the cell and detecting a physical layer cell identity of the cell. To this end, the UE may receive a downlink (DL) synchronization signal from the eNB to adjust the eNB to the DL synchronization, and may obtain information of a cell identity (ID), etc. If the UE is switched on, the PLMN is selected by the NAS. For the selected PLMN, associated RAT(s) may be set. The NAS provides the UE with a list of equivalent PLMNs, that an access stratum (AS) uses for the cell selection or the cell reselection, if available.

With the cell selection, the UE searches for a suitable cell of the selected PLMN and chooses a cell to provide available services. Further, the UE tunes to a control channel of the cell.

The choosing is known as “camping on the cell”.

If the UE finds a more suitable cell according to a cell reselection criteria, the UE reselects the cell and camps on the cell. If the new cell does not belong to at least one tracking area in which the UE is registered, a location registration is performed.

The purpose of camping on a cell in an idle mode may be five:

It enables the UE to receive system information from the PLMN.

When registered and if the UE want to establish an RRC connection, the UE can perform this by initially accessing the network on a control channel of a cell on which the UE is camped.

If the PLMN receives a call for the registered UE, the PLMN can know (in most cases) a set of tracking areas in which the UE is camped. Then, the PLMN can send a “paging” message for the UE on control channels of all the cells in this set of tracking areas. The UE will then receive the paging message because the UE is tuned to the control channel of the cell in one of the registered tracking areas, and the UE can respond on the control channel.

It enables the UE to receive earthquake and tsunami warning system (ETWS) and commercial mobile alert system (CMAS) notifications.

It enables the UE to receive MBMS services.

If the UE is camped on a cell, the UE regularly searches for a better cell according to the cell reselection criteria. If the better cell is found, the found cell is selected by the UE. A change of the cell may imply a change of the RAT.

For normal services, the UE camps on a suitable cell and tunes to a control channel of the cell so that the UE can:

receive system information from the PLMN

receive registration area information, for example, tracking area information from the PLMN

receive other AS and NAS information

if registered, the UE receives paging and notification messages from the PLMN and initiate transfer to a connected mode

In the present disclosure, “barred cell” may refers to a cell on which a UE is not allowed to camp. “Camped on a cell” means that a UE has completed the cell selection/reselection process and has chosen a cell.

If the UE camps on a cell, the UE monitors system information and (in most cases) paging information on the corresponding cell. “Camped on any cell” means that the UE is in an idle mode and has completed the cell selection/reselection process and has chosen a cell irrespective of the PLMN identity. Further, a cell on which the UE camps is called a serving cell.

The description related to the PLMN selection is additionally described in 3GPP TS.22.011 23.122, 36.304.

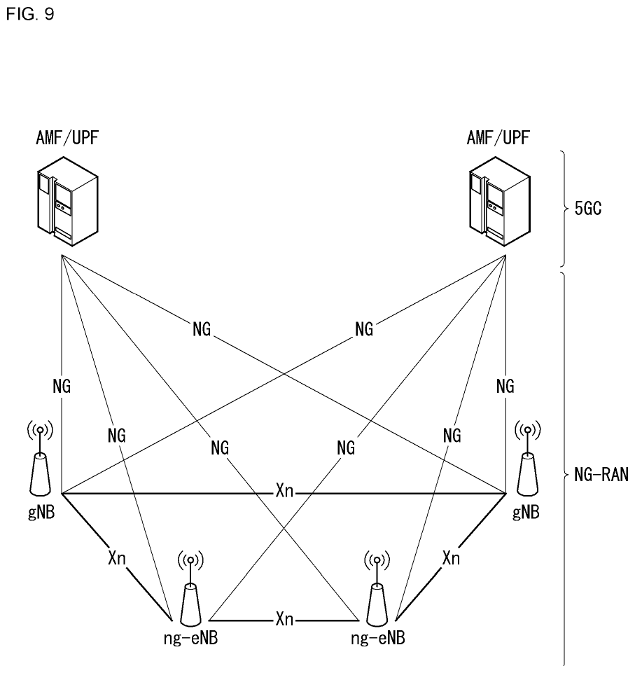

FIG. 9 illustrates an architecture of a general NR-RAN.

Referring to FIG. 9, NG-RAN nodes may be one of the followings.

gNB providing an NR user plane and a control plane protocol towards the UE; or

ng-eNB providing a E-UTRA user plane and the control plane protocol towards the UE; or

The gNB and the ng-eNB are connected to each other via an Xn interface. In addition, the gNB and the ng-eNB are connected to an access and mobility management function (AMF) and to a user plane function (UPF) through an NG-U interface, via an NG interface for 5GC, and more specifically, via an NG-C interface (see 3GPP TS 23.501 [3]).

For reference, an architecture for a functional separation and an F1 interface are defined in 3GPP TS 38.401 [4].

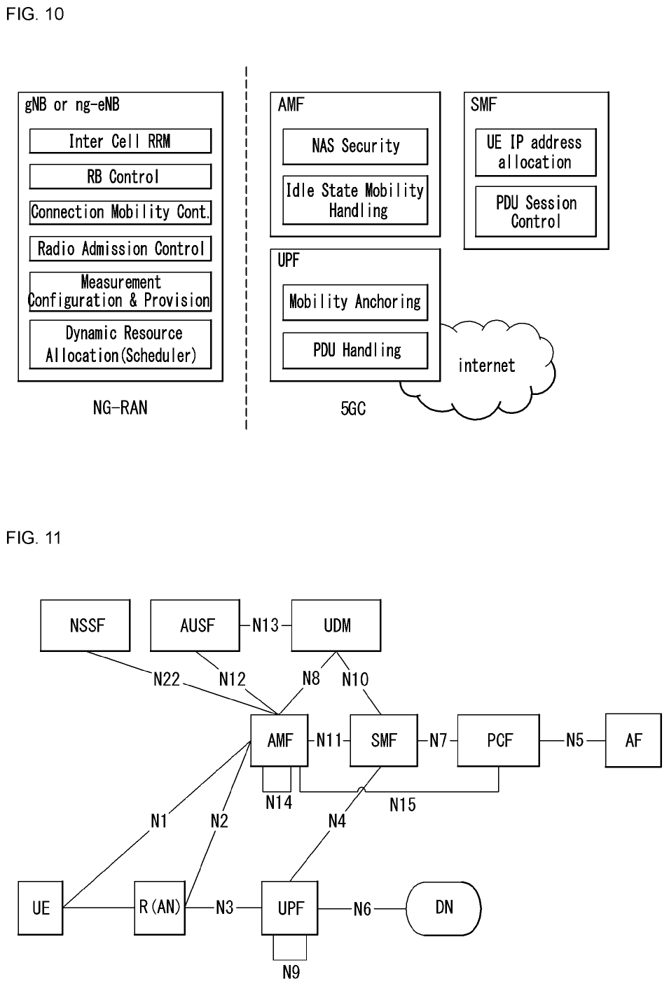

FIG. 10 illustrates a functional separation of a general NG-RAN and 5GC.

Referring to FIG. 10, a yellow box represents logical nodes and a white box represent major functions.

The gNB and the ng-eNB host the following functions.

Radio resource management function: radio bearer control, radio admission control, access mobility control, and dynamic resource allocation for a UE on both uplink and downlink (scheduling)

IP header compression, encryption and data integrity protection;

When the routing for the AMF cannot be determined from the information provided by the UE, selection of the AMF from the IMT-2000 3GPP-UE attachment;

Routing of user plane data to UPF;

Transfer of control plane information to AMF;

Connection establishment and release

Paging message scheduling and transmission

System broadcast information scheduling and transmission (provided by AMF or OAM)

Measurement and measurement reporting configuration for mobility and scheduling

Indication of transport level packet on uplink

Session management;

Network slicing support;

QoS flow management and mapping for data radio bearer

UE support in RRC_INACTIVE state

NAS message distribution function;

Radio access network sharing;

Double connection;

Close linkage between NR and E-UTRA

The AMF hosts the following main functions (see 3GPP TS 23.501 [3]).

NAS signal termination;

NAS signal security;

AS security control;

Transfer of signal between CN nodes for movement between 3GPP access networks;

Idle mode UE connectivity (including paging retransmission control and execution)

Registration area management;

In-system and inter-system mobility support

Access authentication;

Granting access, including roaming permission check;

Mobility management control (subscriptions and policies)

Network slicing support;

SMF selection

The UPF hosts the following main functions (see 3GPP TS 23.501 [3]).

Anchor point for intra-/inter-RAT mobility (if applicable)

External PDU session points interconnected to data network

Packet routing and forwarding;

Packet inspection and user plane part of policy rule enforcement

Traffic usage reporting;

Uplink classifier to support traffic flow to the data network

Branch point for multi-homed PDU session support;

QoS processing for user plane (e.g., packet filtering, gate, UL/DL rate enforcement)

Uplink traffic verification (SDF and QoS flow mapping)

Downlink packet buffering and triggering downlink data notifications

Session management function (SMF) hosts the following key functions (see 3GPP TS 23.501 [3]).

Session management;

UE IP address allocation and management

UP function selection and control;

Configure traffic steering to route traffic to appropriate target in UPF

Policy enforcement and partial control of QoS

Downlink data notification

FIG. 11 illustrates an example of a general architecture of 5G.

The following is a description of each reference interface and node in FIG. 11.

The access and mobility management function (AMF) includes CN inter-node signaling for mobility between 3GPP access networks, termination of a radio access network (RAN) CP interfaces (N2), termination of NAS signaling (N1), registration management (registration area management), idle mode UE reachability, support for network slicing, SMF selection, and the like.

Some or all functions of the AMF may be supported within a single instance of one AMF.

The data network (DN) means, for example, an operator service, an Internet connection, a third party service, or the like. The DN transmits a downlink protocol data unit (PDU) to the UPF or receives, from the UPF, a PDU which is transmitted from the UE.

A policy control function (PCF) provides a function of receiving information on a packet flow from an application server and determining a policy such as mobility management, session management, and the like.

The session management function (SMF) provides a session management function, and when the UE has a plurality of sessions, may be managed by different SMFs for each session.

Some or all functions of the SMF may be supported within a single instance of one SMF.

Unified data management (UDM) stores user subscription data, policy data, and the like.

The user plane function (UPF) transmits a downlink PDU received from the DN to the UE via (R)AN and transmits, to the DN, the uplink PDU received from the UE via the (R)AN.

An application function (AF) interoperates with a 3GPP core network for providing services (e.g., support functions such as influence of applications on traffic routing, access to network capability exposure, interaction with policy frameworks for policy control).

The (radio) access network is referred to as a new radio access network that supports both evolved E-UTRA (E-UTRA) as an evolved version of 4G radio access technology and new radio access technology (NR new radio) (for example, gNB).

The gNB supports functions such as radio resource management functions (i.e., radio bearer control, radio admission control, connection mobility control, dynamic allocation of resources to UE on uplink/downlink) (i.e., scheduling)), and the like.

The user equipment (UE) means a user device.

In the 3GPP system, a conceptual link connecting between NFs in a 5G system is defined as a reference point.

N1 means a reference point between the UE and the AMF, N2 means the reference point between the (R)AN and the AMF, N3 means a reference point between the (R)AN and the UPF, N4 means a reference point between the SMF and the UPF, N6 is a reference point between the UPF and the data network, N9 means a reference point between two core UPFs, N5 means a reference point between the PCF and the AF, N7 means a reference point between the SMF and the PCF, N24 means a reference point between a PCF in a visited network and a PCF in a home network, N8 means a reference point between the UDM and the AMF, N10 means a reference point between the UDM and the SMF, N1 means a reference point between the AMF and the SMF, N12 means a reference point between the AMF and an authentication server function (AUSF), N13 means a reference point between the UDM and the AUSF, N14 means a reference point between two AMFs, N15 means a reference point between the PCF and the AMF in the case of a non-roaming scenario and a reference point between the PCF in the visited network and the AMF in the case of a roaming scenario, N16 means a reference point between two SMFs (in the roaming scenario, a reference point between the SMF in the visited network and the SMF between the home network), N17 means a reference point between the AMF and a 5G-equipment identity register (5G-EIR), N18 means a reference point between the AMF and an unstructured data storage function (UDSF), N22 means a reference point between the AMF and a network slice selection function (NSSF), N23 means a reference point between the PCF and a network data analytics function (NWDAF), N24 means a reference point between the NSSF and the NWDAF, N27 means a reference point between a network repository function (NRF) in the visited network and the NRF in the home network, N31 means a reference point between the NSSF in the visited network and the NSSF in the home network, N32 means a reference point between a security protection proxy (SEPP) in the visited network and SEPP in the home network, N33 means a reference point between a network exposure function (NEF) and the AF, N40 means a reference point between the SMF and a charging function (CHF), and N50 means a reference point between the AMF and a circuit bearer control function (CBCF).

Meanwhile, FIG. 11 illustrates a reference model for a case where a UE accesses one DN using one PDU session, for the convenience of description, but the reference model is not limited thereto.

In the above description, for the convenience of description, the eNB is described based on the EPS system, but the eNB may be replaced by a gNB, a mobility management (MM) function of the MME may be replaced by the AMF, a SM function of S/P-GW may be replaced by the SMF, and a user plane related function of the S/P-GW may be replaced by the 5G system using the UPF and the like.

In the above description, the present disclosure has been described based on EPS, but the content may be supported by similar operations through a similar purpose process/message/information and the like in the 5G system.

Registration

The overall registration process of 5GS is described in section 4.2 of 23.502.

4.2 Connection, Registration and Mobility Management Procedures

4.2.1 General

The Connection Management is used to establish and release the Control Plane signaling connection between the UE and the AMF. The Registration Management is used to register or deregister a UE/user with the 5GS, and establish the user context in the 5GS. The Mobility Management functions are used to keep track of the current location of a UE. The procedures in clause 4.2 provides Connection, Registration and Mobility Management functionality.

4.2.2 Registration Management Procedures

4.2.2.1 General

The Registration and Deregistration procedures in clause 4.2.2 provides the required functionality to register or deregister a UE/user with the 5GS. Additional functionality to support Registration Management for non-3GPP access is defined in clause 4.12. Additional functionality to support Registration Management for specific services such as SMS over NAS is defined in clause 4.13.

4.2.2.2 Registration Procedures

4.2.2.2.1 General

A UE needs to register with the network to get authorized to receive services, to enable mobility tracking and to enable reachability. The Registration procedure is used when the UE needs to perform:

Initial Registration to the 5GS;

Mobility Registration Update upon changing to a new Tracking Area (TA) outside the UE's Registration Area in both CM-CONNECTED and CM-IDLE state, or when the UE needs to update its capabilities or protocol parameters that are negotiated in Registration procedure with or without changing to a new TA;

Periodic Registration Update (due to a predefined time period of inactivity); or

Emergency Registration.

The General Registration call flow in clause 4.2.2.2.2 applies on all these Registration procedures, but the periodic registration need not include all parameters that are used in other registration cases.

Aspects related to dual registration in 3GPP and non-3GPP access are described in clause 4.12. The general Registration call flow in clause 4.2.2.2.2 is also used for the case of registration in 3GPP access when the UE is already registered in a non-3GPP access, and vice versa. Registration in 3GPP access when the UE is already registered in a non-3GPP access scenario may require an AMF change, as further detailed in clause 4.12.8.

The general Registration call flow in clause 4.2.2.2.2 is also used by UEs in limited service state (see TS 23.122 [22]) registering for emergency services only (referred to as Emergency Registration), see TS 23.501 [2] clause 5.16.4.

During the initial registration the PEI is obtained from the UE. The AMF operator may check the PEI with an EIR. The AMF passes the PEI (IMEISV) to the UDM, to the SMF and the PCF, then UDM may store this data in UDR by Nudr_SDM_Update.

NOTE 1: The use of NSI ID in the 5GC is optional and depends on the deployment choices of the operator.

During the registration the Home Network can provide Steering of Roaming information to the UE via the AMF (i.e. a list of preferred PLMN/access technology combinations or HPLMN indication that ‘no change of the “Operator Controlled PLMN Selector with Access Technology” list stored in the UE is needed). The Home Network can include an indication for the UE to send an acknowledgement of the reception of this information. Details regarding the handling of Steering of Roaming information including how this information is managed between the AMF and the UE are defined in TS 23.122 [22].

4.2.2.2.2 General Registration

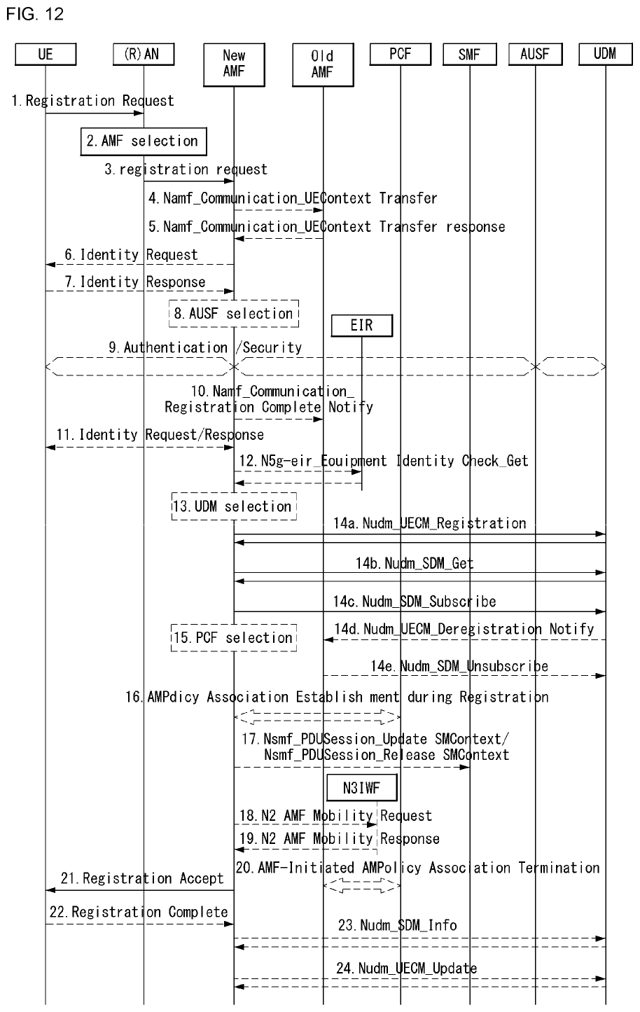

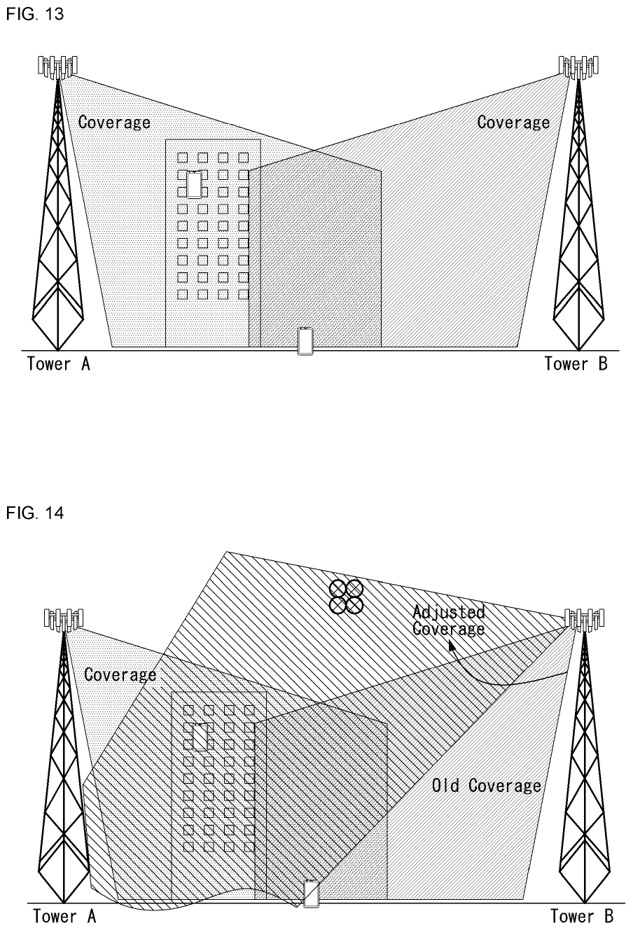

FIG. 12 illustrates a registration procedure to which the present disclosure can be applied.

Referring to FIG. 12, 1. UE to (R)AN: AN message (AN parameters, Registration Request (Registration type, SUCI or 5G-GUTI or PEI, last visited TAI (if available), Security parameters, Requested NSSAI, [Mapping Of Requested NSSAI], Default Configured NSSAI Indication, UE Radio Capability Update, UE MM Core Network Capability, PDU Session status, List Of PDU Sessions To Be Activated, Follow-on request, MICO mode preference, Requested DRX parameters, [LADN DNN(s) or Indicator Of Requesting LADN Information]) and UE Policy Container (the list of PSIs, indication of UE support for ANDSP)).

In the case of NG-RAN, the AN parameters include e.g. SUCI or the 5G-GUTI, the Selected PLMN ID and Requested NSSAI, the AN parameters also include Establishment cause. The Establishment cause provides the reason for requesting the establishment of an RRC connection.

The Registration type indicates if the UE wants to perform an Initial Registration (i.e. the UE is in RM-DEREGISTERED state), a Mobility Registration Update (i.e. the UE is in RM-REGISTERED state and initiates a Registration procedure due to mobility or due to the UE needs to update its capabilities or protocol parameters, or to request a change of the set of network slices it is allowed to use), a Periodic Registration Update (i.e. the UE is in RM-REGISTERED state and initiates a Registration procedure due to the Periodic Registration Update timer expiry, see clause 4.2.2.2.1) or an Emergency Registration (i.e. the UE is in limited service state).

When the UE is performing an Initial Registration the UE shall indicate its UE identity in the Registration Request message as follows, listed in decreasing order of preference:

a native 5G-GUTI assigned by the PLMN to which the UE is attempting to register, if available;

a native 5G-GUTI assigned by an equivalent PLMN to the PLMN to which the UE is attempting to register, if available;

a native 5G-GUTI assigned by any other PLMN, if available.

NOTE 1: This can also be a 5G-GUTIs assigned via another access type.

Otherwise, the UE shall include its SUCI in the Registration Request as defined in TS 33.501 [15].

When the UE is performing an Initial Registration (i.e., the UE is in RM-DEREGISTERED state) with a native 5G-GUTI then the UE shall indicate the related GUAMI information in the AN parameters. When the UE is performing an Initial Registration with its SUCI, the UE shall not indicate any GUAMI information in the AN parameters.

If the UE previously received a UE Configuration Update Command indicating that the UE needs to re-register and that it shall not provide the 5G-GUTI in access stratum signaling when performing the Registration procedure, the UE performs a Mobility Registration and shall not include any GUAMI information in the AN parameters. For an Emergency Registration, the SUCI shall be included if the UE does not have a valid 5G-GUTI available; the PEI shall be included when the UE has no SUPI and no valid 5G-GUTI. In other cases, the 5G-GUTI is included and it indicates the last serving AMF.

The UE may provide the UE's usage setting based on its configuration as defined in TS 23.501 [2] clause 5.16.3.7. In case of Initial Registration or Mobility Registration Update, the UE includes the Mapping Of Requested NSSAI (if available), which is the mapping of each S-NSSAI of the Requested NSSAI to the HPLMN S-NSSAIs, to ensure that the network is able to verify whether the S-NSSAI(s) in the Requested NSSAI are permitted based on the Subscribed S-NSSAIs.

The UE includes the Default Configured NSSAI Indication if the UE is using a Default Configured NSSAI, as defined in TS 23.501 [2].

In the case of Mobility Registration Update, the UE includes in the List Of PDU Sessions To Be Activated the PDU Sessions for which there are pending uplink data. When the UE includes the List Of PDU Sessions To Be Activated, the UE shall indicate PDU Sessions only associated with the access the Registration Request is related to. In some cases (see TS 24.501 [25]) the UE may include PDU Sessions in the List Of PDU Sessions To Be Activated even if there are no pending uplink data for those PDU Sessions.

NOTE 2: A PDU Session corresponding to a LADN is not included in the List Of PDU Sessions To Be Activated when the UE is outside the area of availability of the LADN.

The UE MM Core Network Capability is provided by the UE and handled by AMF as defined in TS 23.501 [2] clause 5.4.4a The UE includes in the UE MM Core Network Capability an indication if it supports Request Type flag “handover” for PDN connectivity request during the attach procedure as defined in clause 5.17.2.3.1 of TS 23.501 [2].

The UE may provide either the LADN DNN(s) or an Indication Of Requesting LADN Information as described in TS 23.501 [2] clause 5.6.5.

If available, the last visited TAI shall be included in order to help the AMF produce Registration Area for the UE.

The Security parameters are used for Authentication and integrity protection, see TS 33.501 [15]. Requested NSSAI indicates the Network Slice Selection Assistance Information (as defined in clause 5.15 of TS 23.501 [2]). The PDU Session status indicates the previously established PDU Sessions in the UE. When the UE is connected to the two AMFs belonging to different PLMN via 3GPP access and non-3GPP access then the PDU Session status indicates the established PDU Session of the current PLMN in the UE.

The Follow-on request is included when the UE has pending uplink signaling and the UE doesn't include List Of PDU Sessions To Be Activated, or the Registration type indicates the UE wants to perform an Emergency Registration. In Initial Registration and Mobility Registration Update, UE provides the UE Requested DRX parameters, as defined in clause 5.4.5 of TS 23.501 [2].

The UE provides UE Radio Capability Update indication as described in TS 23.501 [2].

The UE access selection and PDU session selection identifies the list of UE access selection and PDU session selection policy information stored in the UE, defined in clause 6.6 of TS 23.503 [20]. They are used by the PCF to determine if the UE has to be updated with new PSIs or if some of the stored ones are no longer applicable and have to be removed.

2. If a 5G-GUTI is not included or the 5G-GUTI does not indicate a valid AMF the (R)AN, based on (R)AT and Requested NSSAI, if available, selects an AMF

The (R)AN selects an AMF as described in TS 23.501 [2], clause 6.3.5. If UE is in CM-CONNECTED state, the (R)AN can forward the Registration Request message to the AMF based on the N2 connection of the UE.

If the (R)AN cannot select an appropriate AMF, it forwards the Registration Request to an AMF which has been configured, in (R)AN, to perform AMF selection.

3. (R)AN to new AMF: N2 message (N2 parameters, Registration Request (as described in step 1) and UE Policy Container.

When NG-RAN is used, the N2 parameters include the Selected PLMN ID, Location Information and Cell Identity related to the cell in which the UE is camping, UE Context Request which indicates that a UE context including security information needs to be setup at the NG-RAN.

When NG-RAN is used, the N2 parameters also include the Establishment cause.

Mapping Of Requested NSSAI is provided only if available.

If the Registration type indicated by the UE is Periodic Registration Update, then steps 4 to 20 may be omitted.

4. [Conditional] new AMF to old AMF: Namf_Communication_UEContextTransfer (complete Registration Request) or new AMF to UDSF: Nudsf_Unstructured Data Management_Query( ).

(With UDSF Deployment): If the UE's 5G-GUTI was included in the Registration Reqest and the serving AMF has changed since last Registration procedure, new AMF and old AMF are in the same AMF Set and UDSF is deployed, the new AMF retrieves the stored UE's SUPI and UE context directly from the UDSF using Nudsf_UnstructuredDataManagement_Query service operation or they can share stored UE context via implementation specific means if UDSF is not deployed. This includes also event subscription information by each NF consumer for the given UE. In this case, the new AMF uses integrity protected complete Registration request NAS message to perform and verify integrity protection.

(Without UDSF Deployment): If the UE's 5G-GUTI was included in the Registration Request and the serving AMF has changed since last Registration procedure, the new AMF may invoke the Namf_Communication_UEContextTransfer service operation on the old AMF including the complete Registration Request NAS message, which may be integrity protected, to request the UE's SUPI and UE Context. See clause 5.2.2.2.2 for details of this service operation. In this case, the old AMF uses either 5G-GUTI and the integrity protected complete Registration request NAS message, or the SUPI and an indication that the UE is validated from the new AMF, to verify integrity protection if the context transfer service operation invocation corresponds to the UE requested. The old AMF also transfers the event subscriptions information by each NF consumer, for the UE, to the new AMF.

NOTE 3: The new AMF sets the indication that the UE is validated according to step 9a, in case the new AMF has performed successful UE authentication after previous integrity check failure in the old AMF.

NOTE 4: The NF consumers does not need to subscribe for the events once again with the new AMF after the UE is successfully registered with the new AMF.

If the new AMF has already received UE contexts from the old AMF during handover procedure, then step 4,5 and 10 shall be skipped.

For an Emergency Registration, if the UE identifies itself with a 5G-GUTI that is not known to the AMF, steps 4 and 5 are skipped and the AMF immediately requests the SUPI from the UE. If the UE identifies itself with PEI, the SUPI request shall be skipped. Allowing Emergency Registration without a user identity is dependent on local regulations.

5. [Conditional] old AMF to new AMF: Response to Namf_Communication_UEContextTransfer (SUPI, UE Context in AMF (as per Table 5.2.2.2.2-1)) or UDSF to new AMF: Nudsf_Unstructured Data Management_Query( ). The old AMF may start an implementation specific (guard) timer for the UE context.

If the UDSF was queried in step 4, the UDSF responds to the new AMF for the Nudsf_Unstructured Data Management_Query invocation with the related contexts including established PDU Sessions, the old AMF includes SMF information DNN, S-NSSAI(s) and PDU Session ID, active NGAP UE-TNLA bindings to N3IWF, the old AMF includes information about the NGAP UE-TNLA bindings. If the Old AMF was queried in step 4, Old AMF responds to the new AMF for the Namf_Communication_UEContextTransfer invocation by including the UE's SUPI and UE Context.

If old AMF holds information about established PDU Session(s), the old AMF includes SMF information, DNN(s), S-NSSAI(s) and PDU Session ID(s).

If old AMF holds information about active NGAP UE-TNLA bindings to N3IWF, the old AMF includes information about the NGAP UE-TNLA bindings.

If old AMF fails the integrity check of the Registration Request NAS message, the old AMF shall indicate the integrity check failure.

If old AMF holds information about AM Policy Association, the old AMF includes the information about the AM Policy Association including the policy control request trigger and PCF ID. In the roaming case, V-PCF ID and H-PCF ID are included.

NOTE 5: When new AMF uses UDSF for context retrieval, interactions between old AMF, new AMF and UDSF due to UE signaling on old AMF at the same time is implementation issue.

6. [Conditional] new AMF to UE: Identity Request ( ).

If the SUCI is not provided by the UE nor retrieved from the old AMF the Identity Request procedure is initiated by AMF sending an Identity Request message to the UE requesting the SUCI.

7. [Conditional] UE to new AMF: Identity Response ( ).

The UE responds with an Identity Response message including the SUCI. The UE derives the SUCI by using the provisioned public key of the HPLMN, as specified in TS 33.501 [15].

8. The AMF may decide to initiate UE authentication by invoking an AUSF. In that case, the AMF selects an AUSF based on SUPI or SUCI, as described in TS 23.501 [2], clause 6.3.4.

If the AMF is configured to support Emergency Registration for unauthenticated SUPIs and the UE indicated Registration type Emergency Registration, the AMF skips the authentication or the AMF accepts that the authentication may fail and continues the Registration procedure.

9a. If authentication is required, the AMF requests it from the AUSF; if Tracing Requirements about the UE are available at the AMF, the AMF provides Tracing Requirements in its request to AUSF. Upon request from the AMF, the AUSF shall execute authentication of the UE. The authentication is performed as described in TS 33.501 [15]. The AUSF selects a UDM as described in TS 23.501 [2], clause 6.3.8 and gets the authentication data from UDM.

Once the UE has been authenticated the AUSF provides relevant security related information to the AMF. In case the AMF provided a SUC I to AUSF, the AUSF shall return the SUPI to AMF only after the authentication is successful.

After successful authentication in new AMF, which is triggered by the integrity check failure in old AMF at step 5, the new AMF invokes step 4 above again and indicates that the UE is validated (i.e. through the reason parameter as specified in clause 5.2.2.2.2).

The AMF decides if the Registration Request needs to be rerouted as described in clause 4.2.2.2.3, where the initial AMF refers to the AMF.

9b If NAS security context does not exist, the NAS security initiation is performed as described in TS 33.501 [15].

9c. The AMF initiates NGAP procedure to provide the 5G-AN with security context as specified in TS 38.413 [10] if the 5G-AN had requested for UE Context. In addition, if Tracing Requirements about the UE are available at the AMF, the AMF provides the 5G-AN with Tracing Requirements in the NGAP procedure.

9d. The 5G-AN stores the security context and acknowledges to the AMF. The 5G-AN uses the security context to protect the messages exchanged with the UE as described in TS 33.501 [15].

10. [Conditional] new AMF to old AMF: Namf_Communication_RegistrationCompleteNotify ( ).

If the AMF has changed the new AMF notifies the old AMF that the registration of the UE in the new AMF is completed by invoking the Namf_Communication_RegistrationCompleteNotify service operation.

If the authentication/security procedure fails, then the Registration shall be rejected, and the new AMF invokes the Namf_Communication_RegistrationCompleteNotify service operation with a reject indication reason code towards the old AMF. The old AMF continues as if the UE context transfer service operation was never received.

If one or more of the S-NSSAIs used in the old Registration Area cannot be served in the target Registration Area, the new AMF determines which PDU Session cannot be supported in the new Registration Area. The new AMF invokes the Namf_Communication_RegistrationCompleteNotify service operation including the rejected PDU Session ID and a reject cause (e.g. the S-NSSAI becomes no longer available) towards the old AMF. Then the new AMF modifies the PDU Session Status correspondingly. The old AMF informs the corresponding SMF(s) to locally release the UE's SM context by invoking the Nsmf_PDUSession_ReleaseSMContext service operation.

See clause 5.2.2.2.3 for details of Namf_Communication_RegistrationCompleteNotify service operation.

If new AMF received in the UE context transfer in step 2 the information about the AM Policy Association including the PCF ID(s) and decides, based on local policies, not to use the PCF(s) identified by the PCF ID(s) for the AM Policy Association, then it will inform the old AMF that the AM Policy Association in the UE context is not used anylonger and then the PCF selection is performed in step 15. The old AMF terminates the AM Policy Association to the (V-)PCF identified by the PCF ID in step 20.

11. [Conditional] new AMF to UE: Identity Request/Response (PEI).

If the PEI was not provided by the UE nor retrieved from the old AMF the Identity Request procedure is initiated by AMF sending an Identity Request message to the UE to retrieve the PEI. The PEI shall be transferred encrypted unless the UE performs Emergency Registration and cannot be authenticated.

For an Emergency Registration, the UE may have included the PEI in the Registration Request. If so, the PEI retrieval is skipped.

12. Optionally the new AMF initiates ME identity check by invoking the N5g-eir_EquipmentIdentityCheck_Get service operation (see clause 5.2.4.2.2).

The PEI check is performed as described in clause 4.7.

For an Emergency Registration, if the PEI is blocked, operator policies determine whether the Emergency Registration procedure continues or is stopped.

13. If step 14 is to be performed, the new AMF, based on the SUPI, selects a UDM, then UDM may select a UDR instance. See TS 23.501 [2], clause 6.3.9.

The AMF selects a UDM as described in TS 23.501 [2], clause 6.3.8.

14a-c. If the AMF has changed since the last Registration procedure, or if the UE provides a SUPI which doesn't refer to a valid context in the AMF, or if the UE registers to the same AMF it has already registered to a non-3GPP access (i.e. the UE is registered over a non-3GPP access and initiates this Registration procedure to add a 3GPP access), the new AMF registers with the UDM using Nudm_UECM_Registration and subscribes to be notified when the UDM deregisters this AMF. The UDM stores the AMF identity associated to the Access Type and does not remove the AMF identity associated to the other Access Type. The UDM may store information provided at registration in UDR, by Nudr_DM_Update.

The AMF provides the “Homogenous Support of IMS Voice over PS Sessions” indication (see clause 5.16.3.3 of TS 23.501 [2]) to the UDM. The “Homogenous Support of IMS Voice over PS Sessions” indication shall not be included unless the AMF has completed its evaluation of the support of “IMS Voice over PS Session” as specified in clause 5.16.3.2 of TS 23.501 [2].

NOTE 6: At this step, the AMF may not have all the information needed to determine the setting of the IMS Voice over PS Session Supported indication for this UE (see clause 5.16.3.2 of TS 23.501 [2]). Hence the AMF can send the “Homogenous Support of IMS Voice over PS Sessions” later on in this procedure.

The AMF retrieves the Access and Mobility Subscription data, SMF Selection Subscription data and UE context in SMF data using Nudm_SDM_Get. This requires that UDM may retrieve this information from UDR by Nudr_DM_Query. After a successful response is received, the AMF subscribes to be notified using Nudm_SDM_Subscribe when the data requested is modified, UDM may subscribe to UDR by Nudr_DM_Subscribe. The GPSI is provided to the AMF in the Access and Mobility Subscription data from the UDM if the GPSI is available in the UE subscription data. The UDM may provide indication that the subscription data for network slicing is updated for the UE. If the UE is subscribed to MPS in the serving PLMN, “MPS priority” is included in the Access and Mobility Subscription data provided to the AMF.

The new AMF provides the Access Type it serves for the UE to the UDM and the Access Type is set to “3GPP access”. The UDM stores the associated Access Type together with the serving AMF in UDR by Nudr_DM_Update.

The new AMF creates an UE context for the UE after getting the Access and Mobility Subscription data from the UDM.

For an Emergency Registration in which the UE was not successfully authenticated, the AMF shall not register with the UDM.

For an Emergency Registration, the AMF shall not check for access restrictions, regional restrictions or subscription restrictions. For an Emergency Registration, the AMF shall ignore any unsuccessful registration response from UDM and continue with the Registration procedure.

14d. When the UDM stores the associated Access Type (e.g. 3GPP) together with the serving AMF as indicated in step 14a, it will cause the UDM to initiate a Nudm_UECM_DeregistrationNotification (see clause 5.2.3.2.2) to the old AMF corresponding to the same (e.g. 3GPP) access, if one exists. If the timer started in step 5 is not running, the old AMF may remove the UE context. Otherwise, the AMF may remove UE context when the timer expires. If the serving NF removal reason indicated by the UDM is Initial Registration, then, as described in clause 4.2.2.3.2, the old AMF invokes the Nsmf_PDUSession_ReleaseSMContext (SUPI, PDU Session ID) service operation towards all the associated SMF(s) of the UE to notify that the UE is deregistered from old AMF. The SMF(s) shall release the PDU Session on getting this notification.

If the old AMF has an N2 connection for that UE (e.g. because the UE was in RRC Inactive state but has now moved to E-UTRAN or moved to an area not served by the old AMF), the old AMF shall perform AN Release (see clause 4.2.6) with a cause value that indicates that the UE has already locally released the NG-RAN's RRC Connection.

14e. The Old AMF unsubscribes with the UDM for subscription data using Nudm_SDM_unsubscribe.

15. If the AMF decides to initiate PCF communication, the AMF acts as follows.

If the new AMF decided to contact the (V-)PCF idenfied by PCF ID included in UE context from the old AMF in step 5, the AMF contacts the (V-)PCF identified by the (V-)PCF ID. If the AMF decides to perform PCF discovery and selection and the AMF selects a (V)-PCF and may select an H-PCF (for roaming scenario) as described in TS 23.501 [2], clause 6.3.7.1 and according to the V-NRF to H-NRF interaction described in clause 4.3.2.2.3.3.

16. [Optional] new AMF performs an AM Policy Association Establishment as defined in clause 4.16.1.2. For an Emergency Registration, this step is skipped.

If the new AMF contacts the PCF identified by the (V-)PCF ID received during inter-AMF mobility in step 5, the new AMF shall include the PCF ID(s) in the Npcf_AMPolicyControl Create operation. This indication is not included by the AMF during initial registration procedure.

If the AMF notifies the Mobility Restrictions (e.g. UE location) to the PCF for adjustment, or if the PCF updates the Mobility Restrictions itself due to some conditions (e.g. application in use, time and date), the PCF shall provide the updated Mobility Restrictions to the AMF. If the subscription information includes Tracing Requirements, the AMF provides the PCF with Tracing Requirements.

17. [Conditional] AMF to SMF: Nsmf PDUSession_UpdateSMContext ( ).

For an Emergency Registered UE (see TS 23.501 [2]), this step is applied when the Registration Type is Mobility Registration Update.

The AMF invokes the Nsmf_PDUSession_UpdateSMContext (see clause 5.2.8.2.6) in the following scenario(s):

If the List Of PDU Sessions To Be Activated is included in the Registration Request in step 1, the AMF sends Nsmf_PDUSession_UpdateSMContext Request to SMF(s) associated with the PDU Session(s) in order to activate User Plane connections of these PDU Session(s). Steps from step 5 onwards described in clause 4.2.3.2 are executed to complete the User Plane connection activation without sending MM NAS Service Accept from the AMF to (R)AN described in step 12 of clause 4.2.3.2.

When the serving AMF has changed, the new serving AMF notifies the SMF for each PDU Session that it has taken over the responsibility of the signaling path towards the UE: the new serving AMF invokes the Nsmf_PDUSession_UpdateSMContext service operation using SMF information received from the old AMF at step 5. It also indicates whether the PDU Session is to be re-activated. In the case of PLMN change from V-PLMN to H-PLMN, the new serving AMF only invokes the Nsmf_PDUSession_UpdateSMContext service operation for Home Routed PDU session(s).

NOTE 7: If the UE moves into a V-PLMN, the AMF in the V-PLMN can not insert or change the V-SMF(s) even for Home Routed PDU session(s).

Steps from step 5 onwards described in clause 4.2.3.2 are executed. In the case that the intermediate UPF insertion, removal, or change is performed for the PDU Session(s) not included in “PDU Session(s) to be re-activated”, the procedure is performed without N11 and N2 interactions to update the N3 user plane between (R)AN and SGC.

The AMF invokes the Nsmf_PDUSession_ReleaseSMContext service operation towards the SMF in the following scenario:

If any PDU Session status indicates that it is released at the UE, the AMF invokes the Nsmf_PDUSession_ReleaseSMContext service operation towards the SMF in order to release any network resources related to the PDU Session.

If the serving AMF is changed, the new AMF shall wait until step 18 is finished with all the SMFs associated with the UE. Otherwise, steps 19 to 22 can continue in parallel to this step.

18. New AMF to N3IWF: N2 AMF Mobility Request ( ).

If the AMF has changed and the old AMF has indicated an existing NGAP UE association towards a N3IWF, the new AMF creates an NGAP UE association towards the N3IWF to which the UE is connected. This automatically releases the existing NGAP UE association between the old AMF and the N3IWF

19. N3IWF to new AMF: N2 AMF Mobility Response ( ).

20. [Conditional] old AMF to (V-)PCF: AMF-Initiated Policy Association Termination.

If the old AMF previously initiated a Policy Association to the PCF, and the old AMF did not transfer the PCF ID(s) to the new AMF (e.g. new AMF is in different PLMN), the old AMF performs an AMF-initiated Policy Association Termination procedure, as defined in clause 4.16.3.2, to delete the association with the PCF. In addition, if the old AMF transferred the PCF ID(s) in the UE context but the new AMF informed in step 10 that the AM Policy Association information in the UE context will not be used then the old AMF performs an AMF-initiated Policy Association Termination procedure, as defined in clause 4.16.3.2, to delete the association with the PCF.

21. New AMF to UE: Registration Accept (5G-GUTI, Registration Area, Mobility restrictions, PDU Session status, Allowed NSSAI, [Mapping Of Allowed NSSAI], [Configured NSSAI for the Serving PLMN], [Mapping Of Configured NSSAI], Periodic Registration Update timer, LADN Information and accepted MICO mode, IMS Voice over PS session supported Indication, Emergency Service Support indicator, Accepted DRX parameters, Network support of Interworking without N26, Network Slicing Subscription Change Indication). The Allowed NSSAI for the Access Type for the UE is included in the N2 message carrying the Registration Accept message.

The AMF sends a Registration Accept message to the UE indicating that the Registration Request has been accepted. 5G-GUTI is included if the AMF allocates a new 5G-GUTI. If the UE is already in RM-REGISTERED state via another access in the same PLMN, the UE shall use the 5G-GUTI received in the Registration Accept for both registrations. If no 5G-GUTI is included in the Registration Accept, then the UE uses the 5G-GUTI assigned for the existing registration also for the new registration. If the AMF allocates a new Registration area, it shall send the Registration area to the UE via Registration Accept message. If there is no Registration area included in the Registration Accept message, the UE shall consider the old Registration Area as valid. Mobility Restrictions is included in case mobility restrictions applies for the UE and Registration Type is not Emergency Registration. The AMF indicates the established PDU Sessions to the UE in the PDU Session status. The UE removes locally any internal resources related to PDU Sessions that are not marked as established in the received PDU Session status. If the AMF invokes the Nsmf_PDUSession_UpdateSMContext procedure for UP activation of PDU Session(s) in step 18 and receives rejection from the SMF, then the AMF indicates to the UE the PDU Session ID and the cause why the User Plane resources were not activated. When the UE is connected to the two AMFs belonging to different PLMN via 3GPP access and non-3GPP access then the UE removes locally any internal resources related to the PDU Session of the current PLMN that are not marked as established in received PDU Session status. If the PDU Session status information was in the Registration Request, the AMF shall indicate the PDU Session status to the UE. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the Serving PLMN to the HPLMN S-NSSAIs. The AMF shall include in the Registration Accept message the LADN Information for the list of LADNs, described in TS 23.501 [2] clause 5.6.5, that are available within the Registration area determined by the AMF for the UE. If the UE included MICO mode in the request, then AMF responds whether MICO mode should be used.

In the case of registration over 3GPP access, the AMF sets the IMS Voice over PS session supported Indication as described in clause 5.16.3.2 of TS 23.501 [2]. In order to set the IMS Voice over PS session supported Indication the AMF may need to perform the UE Capability Match Request procedure in clause 4.2.8a to check the compatibility of the UE and NG-RAN radio capabilities related to IMS Voice over PS. If the AMF hasn't received Voice Support Match Indicator from the NG-RAN on time then, based on implementation, AMF may set IMS Voice over PS session supported Indication and update it at a later stage.

In the case of registration over non-3GPP access, the AMF sets the IMS Voice over PS session supported Indication as described in clause 5.16.3.2a of TS 23.501 [2].

The Emergency Service Support indicator informs the UE that emergency services are supported, i.e. the UE is allowed to request PDU Session for emergency services. If the AMF received “MPS priority” from the UDM as part of Access and Mobility Subscription data, based on operator policy, “MPS priority” is included in the Registration Accept message to the UE to inform the UE whether configuration of Access Identity 1 is valid within the selected PLMN, as specified in TS 24.501 [25]. The Accepted DRX parameters are defined in clause 5.4.5 of TS 23.501 [2]. The AMF sets the Interworking without N26 parameter as described in clause 5.17.2.3.1 of TS 23.501 [2].

RRC Inactive Assistance Information might be provided to NG-RAN (see TS 23.501 [2] clause 5.3.3.2.5) in this step.

If the UDM intends to indicate the UE that subscription has changed, the Network Slicing Subscription Change Indication is included. If the AMF includes Network Slicing Subscription Change Indication, then the UE shall locally erase all the network slicing configuration for all PLMNs and, if applicable, update the configuration for the current PLMN based on any received information.

22. [Conditional] UE to new AMF: Registration Complete ( ).

The UE sends a Registration Complete message to the AMF when it has successfully updated itself after receiving any of the [Configured NSSAI for the Serving PLMN], [Mapping Of Configured NSSAI] and a Network Slicing Subscription Change Indication in step 21.

The UE sends a Registration Complete message to the AMF to acknowledge if a new 5G-GUTI was assigned.

When the List Of PDU Sessions To Be Activated is not included in the Registration Request, the AMF releases the signaling connection with UE, according to clause 4.2.6.

When the Follow-on request is included in the Registration Request, the AMF should not release the signaling connection after the completion of the Registration procedure.

If the AMF is aware that some signaling is pending in the AMF or between the UE and the SGC, the AMF should not release the signaling connection immediately after the completion of the Registration procedure.

23. [Conditional] AMF to UDM: If the Access and Mobility Subscription data provided by UDM to AMF in 14b includes Steering of Roaming information with an indication that the UDM requests an acknowledgement of the reception of this information from the UE, the AMF provides the UE acknowledgement to UDM using Nudm_SDM_Info. For more details regarding the handling of Steering of Roaming information refer to TS 23.122 [22].

The AMF also uses the Nudm_SDM_Info service operation to provide an acknowledgment to UDM that the UE received the Network Slicing Subscription Change Indication (see step 21 and step 22) and acted upon it.

24. [Conditional] AMF to UDM: After step 14a, and in parallel to any of the preceding steps, the AMF shall send a “Homogeneous Support of IMS Voice over PS Sessions” indication to the UDM using Nudm_UECM_Update:

If the AMF has evaluated the support of IMS Voice over PS Sessions, see clause 5.16.3.2 of TS 23.501 [2], and

If the AMF determines that it needs to update the Homogeneous Support of IMS Voice over PS Sessions, see clause 5.16.3.3 of TS 23.501 [2].

The mobility related event notifications towards the NF consumers are triggered at the end of this procedure for cases as described in clause 4.15.4.

Before drones were widely used in real life, communication services were provided through UEs in an office/home and the like, or UEs on the street. In order to provide the most efficient wireless coverage through a small number of antennas, radio equipments such as antennas are installed at the highest point in the area, in particular, a location of an antenna is adjusted to provide an optimal communication environment on the ground or in a building.

FIG. 13 illustrates an embodiment of a radio radiation pattern of radio equipment to which the present disclosure can be applied.

Referring to FIG. 13, since the drone flies high in the air due to characteristics of a drone operation method, the drone may be out of wireless coverage provided by tower A and tower B. In this case, the network may consider a method for changing a radiation pattern of a radio signal by adjusting the antenna to provide the wireless coverage to the drone.

FIG. 14 illustrates an embodiment of a method for changing a radiation pattern of a radio signal to which the present disclosure may be applied.

Referring to FIG. 14, the tower B may provide communication services to a drone by adjusting an antenna angle. However, this method reduces the radio radiation pattern towards the ground, resulting in a decrease in radio quality for the UEs actually on the ground.

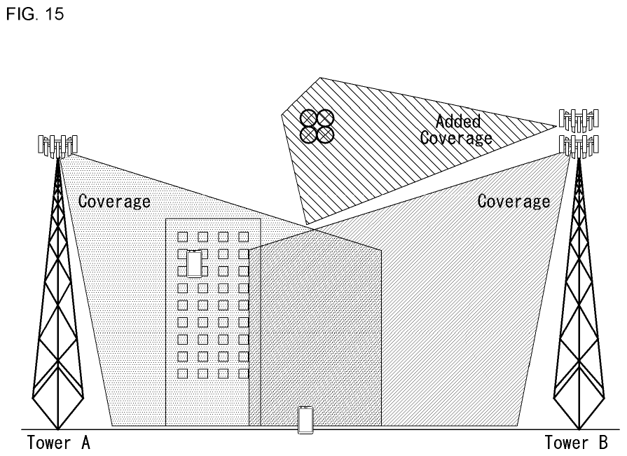

FIG. 15 illustrates an embodiment of a method for changing a radiation pattern of a radio signal to which the present disclosure may be applied.

As a method for supplementing the problem of FIG. 14, referring to FIG. 15, a mobile communication service provider may install additional wireless devices and antennas to provide wireless coverage for new equipment such as drones without degrading the quality of communication services to the existing UEs.

However, in the above situations, when new equipments provide wireless communication services to the existing UEs, resources to be provided for communication equipments such as the drones are allocated to other UEs, so communication of important purposes such as control of drones may be affected. In addition, for faster and error-free communication, a subscriber using communication equipment such as a drone may subscribe to additional services or a different kind of services from a general user. In this case, if such new equipment is provided to all UEs, it is impossible to differentiate and optimize services for communication equipment such as drones.

Accordingly, the present disclosure first proposes a method for enabling a mobile communication service provider or a network to provide differentiated communication services to each UE according to a service type, a contract, a type, etc., of a UE and efficiently distributing a network and radio resources based on the communication services and providing an environment optimized for each communication service.

To this end, in the present disclosure, the network may store, in subscriber information servers (e.g., HLR, HSS, UDM), and the like, information on services subscribed by each UE and information on an area where services can be provided to each UE. The network may determine whether to provide communication services to each UE based on information on areas, places, or the like where each UE is currently located, and thus may provide or reject communication services.

For example, each network may store, for each subscriber, information on a maximum height at which each subscriber can receive services when storing the information on the communication services subscribed by the subscriber.

Based on this information, if a UE transitions from an idle mode to a connected mode, a core network may transmit information to a wireless network. On the basis of the information, the wireless network may stop providing the communication services when the UE exceeds the height specified in the information based on the height of each current UE.

### Embodiment 1

For example, the network and the UE can operate as follows.

The UE A and the UE B subscribe to MNO C. As the subscription condition, the UE A may be subscribed to receive a service up to a low altitude (50 m), for example, and the UE B may be subscribed to receive a service up to a medium altitude (400 m), for example.

Both the UE A and the UE B are on the ground and start data communication. That is, both the UE A and the UE B transition from the idle mode to the connected mode, the core network transfers service restriction information on each UE to the wireless network.

Both the UE A and the UE B are loaded on drone and start to rise.

Both the UE A and the UE B reach 51 m altitude. The wireless network may no longer provide the communication services to the UE A according to the service restriction information. However, the communication services may be continuously provided to the UE B.

More specifically, when the wireless network no longer provides the communication services to the UE A, the wireless network may operate as follows.

option 1: Connection release between the UE A and the network.

option 2: No allocation of resources between the UE A and the network (e.g., maintaining only the control plane).

For example, when the wireless network operates as option 1, if the UE is disconnected from the network, the UE may perform an operation for requesting communication services to the network again. In this case, even though the UE is connected, the UE does not receive the communication services from the network, and thus the access of the UE may cause unnecessary congestion in the wireless network. Therefore, the network needs to properly block access from the UE A.

As a solution to this problem, when the network releases the connection with the UE, the network may inform the UE of the reason for the connection release, and may additionally provide information as to whether to try to access again in some cases. The UE receiving the information attempts to access again if the above conditions are met when data to be transmitted or signaling occurs, and otherwise, the UE does not attempt to access.

For example, the network may disconnect from the UE when the UE rises above a predetermined height which is predetermined or allowed. In this process, the network may transmit to the UE information indicating disconnection because the UE rises above the designated altitude. Based on this information, the UE may no longer attempt to access the network until the UE goes back below a certain altitude.

To support this, for example, the network may include information on why the connection is released in an RRC connection release or a similar purpose or name message, or a similar purpose NAS message. For example, the network may transmit information such as ‘not allowed area’ or ‘height is not allowed’.

Table 2 shows an example of an RRCRelease message to which the present disclosure can be applied.

TABLE 2
-- ASN1START
-- TAG-RRCRELEASE-START

| | |
|---|---|
| RRCRelease ::= | SEQUENCE { |

| | |
|---|---|
| rrc-TransactionIdentifier | RRC- |

Transactionidentifier,

| | |
|---|---|
| criticalExtensions | CHOICE { |

| | |
|---|---|
| rrcRelease | RRCRelease-IEs, |

| | |
|---|---|
| criticalExtensionsFuture | SEQUENCE { } |

}

}

| | |
|---|---|
| RRCRelease-IEs ::= | SEQUENCE { |

redirectedCarrierInfo

RedirectedCarrierInfo

| | |
|---|---|
| OPTIONAL, | -- Need N |

cellReselectionPriorities

CellReselectionPriorities

| | |
|---|---|
| OPTIONAL, | -- Need R |

| | |
|---|---|
| suspendConfig | SuspendConfig |

| | |
|---|---|
| OPTIONAL, | -- Need R |

| | |
|---|---|
| deprioritisationReq | SEQUENCE { |

| | |
|---|---|
| deprioritisationType | ENUMERATED |

{frequency, nr},

| | |
|---|---|
| deprioritisationTimer | ENUMERATED |

{min5, min10, min15, min30}

}

| | |
|---|---|
| OPTIONAL, | -- Need R |

| | |
|---|---|
| releasecause | releasecause |

| | |
|---|---|
| OPTIONAL, | -- Need R |

RestrictedAreaInfo RestrictedAreaInfo
RestrictedAreaInfo

| | |
|---|---|
| OPTIONAL, | -- Need N |

| | |
|---|---|
| lateNonCriticalExtension | OCTET STRING |

OPTIONAL,

| | |
|---|---|
| nonCriticalExtension | SEQUENCE{ } |

OPTIONAL
}

| RedirectedCarrierInfo ::= | | CHOICE { |
|---|---|---|
| | nr | CarrierInfoNR, |

eutra

RedirectedCarrierInfo-EUTRA,

...

}

| | |
|---|---|
| RedirectedCarrierInfo-EUTRA ::= | SEQUENCE { |

| | |
|---|---|
| eutraFrequency | ARFCN- |

ValueEUTRA,

| | |
|---|---|
| cnType-r15 | ENUMERATED |

{epc,fiveGC}
OPTIONAL
}

| CarrierInfoNR ::= | | SEQUENCE { |
|---|---|---|
| | carrierFreq | ARFCN-ValueNR, |

ssbSubcarrierSpacing

SubcarrierSpacing,

| | |
|---|---|
| smtc | SSB-MTC |

| | |
|---|---|
| OPTIONAL, | -- Need S |

...

}

| SuspendConfig ::= | | SEQUENCE { |
|---|---|---|
| | fullI-RNTI | I-RNTI-Value, |
| | shortI-RNTI | ShortI-RNTI-Value, |

| | |
|---|---|
| ran-PagingCycle | PagingCycle, |
| ran-NotificationAreaInfo | RAN- |

NotificationAreaInfo

| | |
|---|---|
| OPTIONAL, | -- Need M |

| | |
|---|---|
| t380 | PeriodicRNAU- |

TimerValue

| | |
|---|---|
| OPTIONAL, | -- Need R |

nextHopChainingCount

NextHopChainingCount,

...

}

| | |
|---|---|
| PeriodicRNAU-TimerValue ::= | ENUMERATED { min5, |

min10, min20, min30, min60, min120, min360, min720}

| | |
|---|---|
| CellReselectionPriorities ::= | SEQUENCE { |

freqPriorityListEUTRA

FreqPriorityListEUTRA

| | |
|---|---|
| OPTIONAL, | -- Need M |

freqPriorityListNR

FreqPriorityListNR

| | |
|---|---|
| OPTIONAL, | -- Need M |

| | |
|---|---|
| t320 | ENUMERATED {min5, |

min10, min20, min30, min60, min120, min180, spare1}

| | |
|---|---|
| OPTIONAL, | -- Need R |

...

}

| | |
|---|---|
| PagingCycle ::= | ENUMERATED {rf32, |

rf64, rf128, rf256}

| | |
|---|---|
| FreqPriorityListEUTRA ::= | SEQUENCE (SIZE |

(1..maxFreq)) OF FreqPriorityEUTRA

| | |
|---|---|
| FreqPriorityListNR ::= | SEQUENCE (SIZE |

(1..maxFreq)) OF FreqPriorityNR

| FreqPriorityEUTRA ::= | | SEQUENCE { |
|---|---|---|
| | carrierFreq | ARFCN-ValueEUTRA, |

cellReselectionPriority

CellReselectionPriority,

cellReselectionSubPriority

CellReselectionSubPriority

| | |
|---|---|
| OPTIONAL | -- Need R |

}

| FreqPriorityNR ::= | | SEQUENCE { |
|---|---|---|
| | carrierFreq | ARFCN-ValueNR, |

cellReselectionPriority

CellReselectionPriority,

cellReselectionSubPriority

CellReselectionSubPriority

| | |
|---|---|
| OPTIONAL | -- Need R |

}

| RAN-NotificationAreaInfo ::= | | CHOICE { |
|---|---|---|
| | cellList | PLMN-RAN- |

AreaCellList,

| | |
|---|---|
| ran-AreaConfigList | PLMN-RAN- |

AreaConfigList,

...

}

| | |
|---|---|
| PLMN-RAN-AreaCellList ::= | SEQUENCE (SIZE (1.. |

maxPLMNIdentities)) OF PLMN-RAN-AreaCell

| | |
|---|---|
| PLMN-RAN-AreaCell ::= | SEQUENCE { |

| | |
|---|---|
| plmn-Identity | PLMN-Identity |

| | |
|---|---|
| OPTIONAL, | -- Need S |

| | |
|---|---|
| ran-AreaCells | SEQUENCE (SIZE |

(1..32)) OF CellIdentity
}

| | |
|---|---|
| PLMN-RAN-AreaConfigList ::= | SEQUENCE (SIZE |

(1..maxPLMNIdentities)) OF PLMN-RAN-AreaConfig

| | |
|---|---|
| PLMN-RAN-AreaConfig ::= | SEQUENCE { |

| | |
|---|---|
| plmn-Identity | PLMN-Identity |

| | |
|---|---|
| OPTIONAL, | -- Need S |

| | |
|---|---|
| ran-Area | SEQUENCE (SIZE |

(1..16)) OF RAN-AreaConfig
}

| | |
|---|---|
| RAN-AreaConfig ::= | SEQUENCE { |

| | |
|---|---|
| trackingAreaCode | TrackingAreaCode, |
| ran-AreaCodeList | SEQUENCE (SIZE (1..32 |

| | | |
|---|---|---|
| OF RAN-AreaCode | OPTIONAL | -- Need R |

}
-- TAG-RRCRELEASE-STOP
-- ASN1STOP

Editor's Note: FFS Whether RejectWaitTimer is needed in RRCRelease message.

Table 3 shows an example of RRCRelease field descriptions to which the present disclosure can be applied.

TABLE 3
RRCRelease field descriptions

cnType
Indicate that the UE is redirected to EPC or 5GC.
deprioritisationReq
Indicates whether the current frequency or RAT is to be
de-prioritised. The UE shall be able to store a
deprioritisation request for up to X frequencies (applicable
when receiving another frequency specific deprioritisation
request before T325 expiry).
deprioritisationTimer
Indicates the period for which either the current carrier
frequency or NR is deprioritised. Value min N corresponds to N
minutes.
suspendConfig
Indicates configuration for the RRC_INACTIVE state.
t380
Refers to the timer that triggers the periodic RNAU
procedure in UE. Value min 5 corresponds to 5 minutes, value
min 10 corresponds to 10 minutes and so on.
ran-PagingCycle
Refers to the UE specific cycle for RAN-initiated paging.
Value rf32 corresponds to 32 radio frames, rf64 corresponds to
64 radio frames and so on.
redirectedCarrierInfo
Indicates a carrier frequency (downlink for FDD) and is
used to redirect the UE to an NR or an inter-RAT carrier
frequency, by means of the cell selection upon leaving
RRC_CONNECTED as specified in TS 38.304 [20]
releasecause
Indicates why a connection is release. For example, this
may indicate that the connection is release because the UE
entered an area which is not allowed for the UE. For example,
if a UE rise above the threshold set for the UE.

5.3.8.3 Reception of the RRCRelease by the UE

The UE shall:

1> delay the following actions defined in this sub-clause 60 ms from the moment the RRCRelease message was received or optionally when lower layers indicate that the receipt of the RRCRelease message has been successfully acknowledged, whichever is earlier;

1> stop timer T320, if running;

1> if the RRCRelease message includes redirectedCarrierinfo indicating redirection to eutra:

2> if cnType is included:

3> the received cnType is provided to upper layers;

NOTE: Handling the case if the E-UTRA cell selected after the redirection does not support the core network type specified by the cnType, is up to UE implementation.

1> if the RRCRelease message includes the cellReselectionPriorities:

2> store the cell reselection priority information provided by the cellReselectionPriorities;

2> if the t320 is included:

3> start timer T320, with the timer value set according to the value of t320;

1> else:

2> apply the cell reselection priority information broadcast in the system information;

1> if deprioritisationReq is included:

2> start or restart timer T325 with the timer value set to the deprioritisationTimer signalled;

2> store the deprioritisationReq until T325 expiry;

1> if releasecuase is included:

2> if releasecuase indicates that the UE entered into an area which is not allowed for the UE;

2> start timer T3XY;

3> set notallowedarea to true

1> if the RRCRelease includes suspendConfig:

2> apply the received suspendConfig;

2> store fulll-RNTI, shortl-RNTI, nextHopChainingCount, t380 and ran-PagingCycle provided in suspendConfig;

2> reset MAC;

2> re-establish RLC entities for SRB1;

2> if the RRCRelease message with suspendConfig was received in response to an RRCResumeRequest or an RRCResumeRequest1:

3> stop the timer T319 if running;

3> replace any previously stored security context with newly received security context in the suspendConfig;

3> replace the previously stored C-RNTI with the temporary C-RNTI in the cell the UE has received the RRCRelease message;

3> replace the previously stored cellIdentity with the cellIdentity of the cell the UE has received the RRCRelease message;

3> replace the previously stored physical cell identity with the physical cell identity of the cell the UE has received the RRCRelease message;

2> else:

3> store the UE AS Context including the current RRC configuration, the current security context, the PDCP state including ROHC state, SDAP configuration, C-RNTI used in the source PCell, the cellIdentity and the physical cell identity of the source PCell;

2> suspend all SRB(s) and DRB(s), except SRB0;

2> start timer T380, with the timer value set to t380;

2> indicate the suspension of the RRC connection to upper layers;

2> enter RRC_INACTIVE and perform procedures as specified in TS 38.304 [21]

1> else

2> perform the actions upon going to RRC_IDLE as specified in 5.3.11, with the release cause ‘other’.

Editor's Note: FFS Whether there needs to be different release causes and actions associated.

5.3.8.4 T320 expiry

The UE shall:

1> if T320 expires:

2> if stored, discard the cell reselection priority information provided by the cellReselectionPriorities or inherited from another RAT;

2> apply the cell reselection priority information broadcast in the system information.

5.3.X.X

When RRC_Connection is requested by upper layer:

1> if notallowedarea is set to true:

2> indicates to upper layer that connection establishment is not allowed.

1> else if access barring is not applicable:

2> proceeds to RRC Connection establishment.

5.3.X.Y

while notallowedarea is set to true:

1> if RestrictedAreaInfo is available:

2> if the UE leaves the area defined by RestrictedAreaInfo:

3> set notallowedarea to false

2> start timer T3XY;

3> set notallowedarea to true

In another embodiment, the network may transmit to the UEs information about conditions under which the UE can attempt to access the UE, and check whether the UE can attempt to access as indicated by this information, and attempt to access only when the UE passes the check.

For example, the network may transmit information on certain area information or height information. If a cell may prohibit a UE rising above 200 m among the UEs from accessing, the UE, each UE may determine whether to attempt to access the cell based on information as to whether the height of the UE is 200 m or higher or lower.

SIB1

SIB1 contains information relevant when evaluating if a UE is allowed to access a cell and defines the scheduling of other system information. It also contains radio resource configuration information that is common for all UEs and barring information applied to the unified access control.

Signaling radio bearer: N/A

RLC-SAP: TM

Logical channels: BCCH

Direction: Network to UE

Table 4 shows an example of a SIB1 message to which the present disclosure can be applied.

-- ASN1START
-- TAG-SIB1-START

| | |
|---|---|
| SIB1 ::= | SEQUENCE { |

| | |
|---|---|
| cellSelectionInfo | SEQUENCE { |

| | |
|---|---|
| q-RxLevMin | Q-RxLevMin, |
| q-RxLevMinOffset | INTEGER (1..8) |

OPTIONAL, -- Need R

| | |
|---|---|
| q-RxLevMinSUL | Q-RxLevMin |

OPTIONAL, -- Need R

| | |
|---|---|
| q-QualMin | Q-QualMin |

OPTIONAL, -- Need R

| | |
|---|---|
| q-QualMinOffset | INTEGER (1..8) |

OPTIONAL -- Need R

}

OPTIONAL, -- Need S

cellAccessRelatedInfo

CellAccessRelatedInfo,

connEstFailureControl

ConnEstFailureControl
OPTIONAL, -- Need R

| | |
|---|---|
| si-SchedulingInfo | Si-SchedulingInfo |

OPTIONAL, -- Need R

servingCellConfigCommon

ServingCellConfigCommonSIB
OPTIONAL, -- Need R

| | |
|---|---|
| ims-EmergencySupport | ENUMERATED {true} |

OPTIONAL, -- Need R

| | |
|---|---|
| eCallOverIMS-Support | ENUMERATED {true} |

OPTIONAL, -- Cond Absent

| | |
|---|---|
| ue-TimersAndConstants | UE- |

TimersAndConstants
OPTIONAL, -- Need R

| | |
|---|---|
| uac-BarringInfo | SEQUENCE { |

| | |
|---|---|
| uac-BarringForCommon | UAC- |

BarringPerCatList
OPTIONAL, -- Need S

| | |
|---|---|
| uac-BarringPerPLMN-List | UAC- |

BarringPerPLMN-List
OPTIONAL, -- Need S

| | |
|---|---|
| uac-BarringInfoSetList | UAC- |

BarringInfoSetList,

uac-AccessCategory1-SelectionAssistanceInfo

CHOICE {

| | |
|---|---|
| plmnCommon | UAC- |

AccessCategory1-SelectionAssistanceInfo,

| | |
|---|---|
| individualPLMNList | SEQUENCE |

(SIZE (2..maxPLMN)) OF UAC-AccessCategory1-
SelectionAssistanceInfo

}

OPTIONAL

}

OPTIONAL, -- Need R

| | |
|---|---|
| useFullResumeID | ENUMERATED {true} |

OPTIONAL, -- Need N

| | |
|---|---|
| lateNonCriticalExtension | OCTET STRING |

OPTIONAL,

| | |
|---|---|
| nonCriticalExtension | SEQUENCE{ } |

OPTIONAL
}
UAC-AccessCategory1-SelectionAssistanceInfo ::=

ENUMERATED {a, b, c}

-- TAG-SIB1-STOP
-- ASN1STOP

Table 5 shows an example of SIB1 field descriptions to which the present disclosure can be applied.

TABLE 5
SIB1 field descriptions

q-QualMin
Parameter “Qqualmin” in TS 38.304 [20], applicable for
serving cell. If the field is not present, the UE applies the
(default) value of negative infinity for Qqualmin.
q-QualMinOffset
Parameter “Qqualminoffset” in TS 38.304 [20]. Actual
value Qqualminoffset = field value [dB]. If cellSelectionInfo
is not present or the field is not present, the UE applies the
(default) value of 0 dB for Qqualminoffset. Affects the minimum
required quality level in the cell.
q-RxLevMin
Parameter “Qrxlevmin” in TS 38.304 [20], applicable for
serving cell.
q-RxLevMinOffset
Parameter “Qrxlevminoffset” in TS 38.304 [20]. Actual
value Qrxlevminoffset = field value * 2 [dB]. If absent, the UE
applies the (default) value of 0 dB for Qrxlevminoffset.
Affects the minimum required Rx level in the cell.
q-RxLevMinSUL
Parameter “QrxlevminSUL” in TS 38.304 [4], applicable for
serving cell
uac-BarringForCommon
Common access control parameters for each access
category. Common values are used for all PLMNs, unless
overwritten by the PLMN specific configuration provided in uac-
BarringPerPLMN-List. The parameters are specified by providing
an index to the set of configurations (uac-BarringInfoSetList).
UE behaviour upon absence of this field is specified in section
5.3.14.2.
useFullResumeID
Indicates which resume identifier and Resume request
message should be used. UE uses full I-RNTI and
RRCResumeRequest1 if the field is present, or short I-RNTI and
RRCResumeRequest if the field is absent.
uac-AccessCategory1-SelectionAssistanceInfo
Information used to determine whether Access Category 1
applies to the UE, as defined in [25]. A UE compliant with this
version of the specification shall ignore this field.

CellAccessRelatedInfo

The IE CellAccessRelatedInfo indicates cell access related information for this cell.

Table 6 shows an example of a CellAccessRelatedInfo information element to which the present disclosure can be applied.

TABLE 6

| -- ASN1START | |
|---|---|
| -- TAG-CELL-ACCESS-RELATED-INFO-START | |
| CellAccessRelatedInfo ::= | SEQUENCE { |

| | |
|---|---|
| plmn-IdentityList | PLMN- |

IdentityInfoList,

| | |
|---|---|
| cellReservedForOtherUse | ENUMERATED |

{true} OPTIONAL, -- Need R
cellAccessRestriction cellAccessRestriction OPTIONAL,
-- Need R

...

}
-- TAG- CELL-ACCESS-RELATED-INFO-STOP
-- ASN1STOP

Table 7 shows an example of CellAccessRelatedInfo field descriptions to which the present disclosure can be applied.

TABLE 7
CellAccessRelatedInfo field descriptions

cellReservedForOtherUse
Indicates whether the cell is reserved, as defined in
38.304 [20]. The field is applicable to all PLMNs.
cellAccessRestriction
Indicates cell access restriction information regarding
which uE is allowed or not allowed for access.
plmn-IdentityList
The PLMN-IdentityList is used to configure a set of PLMN-
IdentityInfo elements. Each of those elements contains a list
of one or more PLMN Identities and additional information
associated with those PLMNs. The total number of PLMNs in the
PLMNIdentitynfoList does not exceed 12. The PLMN index is
defined as b1 + b2 + . . . + b (n − 1) + i If this PIMN
is included at the n-th entry of PLMN-IdentityInfoList and the i-th
entry of its corresponding PLMN-IdentityInfo, where b(j) is the
number of PLMN-Identity entries in each PLMN-IdentityInfo respectively.

5.2.2.4.2 Actions upon Reception of the SIB1

Upon receiving the SIB1 the UE shall:

1> store the acquired SIB1;

1> if the cellAccessRelatedInfo contains an entry with the PLMN-Identity of the selected PLMN:

2> in the remainder of the procedures use plmn-IdentityList, trackingAreaCode, and cellIdentity for the cell as received in the corresponding PLMN-IdentityInfo containing the selected PLMN;

1> if the cellAccessRestriction exist:

2> if the UE meets the condition indicated by cellAccessRestrction, consider the access to the cell is prohibited.

3> for example, if cellAccessRestriction indicates that the UE with height above XYZ m is not allowed, and if the UE's height is above XYZ, the UE consider the access to the cell is prohibited. Otherwise, the UE check whether access to the cell is prohibited or not depending on other information available.

1> if in RRC_CONNECTED while T311 is not running:

2> disregard the frequencyBandList, if received, while in RRC_CONNECTED;

2> forward the cellIdentity to upper layers;

2> forward the trackingAreaCode to upper layers;

In the above embodiment, the present disclosure has described the location of the UE as an example, but various conditions may be applied depending on the type of the UE, for example, whether the UE is installed in a drone, whether the UE is a car UE, or the like.

For example, when the wireless network operates like the option 2, the network needs to permit transmission of control plane signaling (e.g., RRC, NAS related messages) of the UE and block other user data transmission. To this end, the network may instruct a UE to transmit only a control signal or signaling while maintaining the connection with the UE, and a UE to block other data transmission. When the control signal or the signaling occurs in the UE, the UE receiving the instruction may instruct the same to the network or transmit a buffer status report or the like thereto, and when other data is generated, the UE may request allocation of radio resources to the network or may not perform the transmission of the buffer status report, etc.

For example, the network may inform the UE of whether or not to trigger buffer status reporting to any logical channel or logical channel group. Based on this information, when data or signaling occurs in any logical channel or logical channel group, the UE may actually perform the buffer status reporting or the buffer status triggering only when the network is allowed to trigger or report the buffer status reports.

As another method, the network can issue a suspend command for the configured logical channel, and the like. That is, when the network suspends for a specific logical channel, the UE may transfer data or signaling generated in an unsuspended channel to the network.

As another method, the UE may also transfer the same information through the RRC.

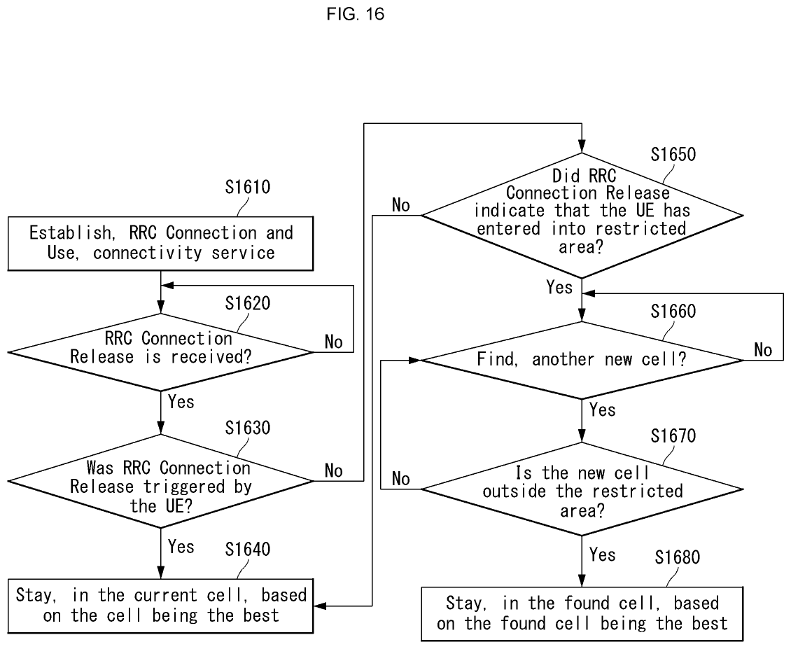

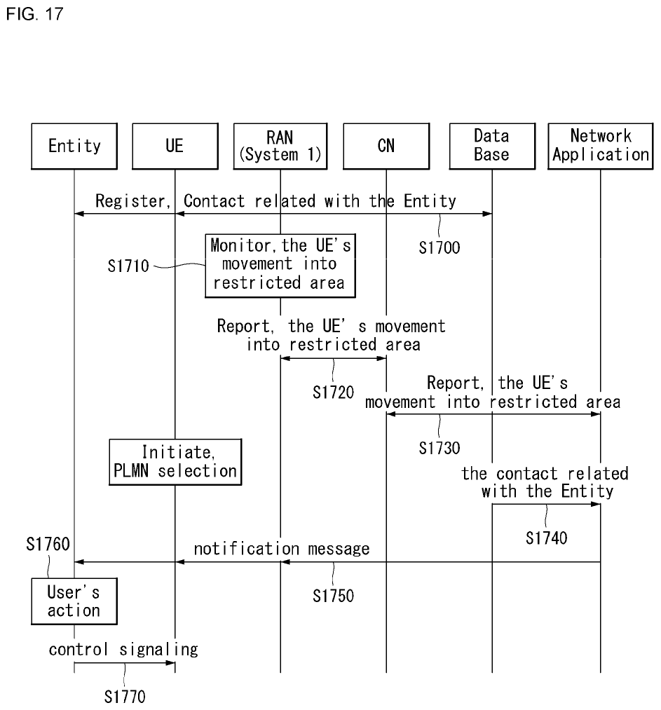

FIG. 16 illustrates an embodiment of the UE to which the present disclosure can be applied.

Referring to FIG. 16, the UE may perform the registration process with the network.

The UE establishes the RRC connection with the network, initiates communication, and transmits and receives data through the communication (S1610).

The UE checks whether the RRC connection release message has been received (S1620). In more detail, when the UE does not receive the RRC connection release message, the UE may periodically perform the operation S1620.

The UE checks whether the RRC connection release message is triggered by the connection release request of the UE (S1630).

The UE enters the idle mode, and stays in the current cell when the current cell is still an optimal cell (S1640). In more detail, when the RRC connection release message received by the UE is triggered from the UE, the UE stays in the current cell, and the subsequent processes may be terminated.

The UE checks whether the restricted area information is included in the received RRC connection Release message (S1650). For example, this message includes information on whether the RRC connection was released because the UE entered above a certain altitude, or the altitude allowed to the UE. In addition, such restricted area information includes a cause that the network transmits an RRC connection release message.

The UE enters the idle mode and performs a cell selection process (S1660).

The UE checks whether the newly found cell corresponds to the cell restriction condition indicated in S1650 (S1670). Through this, the UE may first select a cell that does not correspond to the restricted area information.

The UE camps on the newly found cell (S1680). To this end, the UE may transmit a registration request message to the network associated with the newly found cell.

In order for the wireless network to perform the above operation, the wireless network needs to be aware of the service conditions of each UE. To this end, in the present disclosure, the core network may transmit information on service restriction conditions to the wireless network. This may be set for each cell or for each UE.

9.3.1.85 Mobility Restriction List

This IE defines roaming or access restrictions for subsequent mobility action for which the NR-RAN provides information about the target of the mobility action towards the UE, e.g., handover, or for SCG selection during dual connectivity operation or for assigning proper RNAs. If the NG-RAN receives the Mobility Restriction List IE, it shall overwrite previously received mobility restriction information. NG-RAN behaviour upon receiving this IE is specified in TS 23.501 [9].

Tables 8 and 9 show examples of a mobility restriction list to which the present disclosure can be applied.

TABLE 8

| | | | IE type and | |
|---|---|---|---|---|
| IE/Group Name | Presence | Range | reference | Semantics description |
| Serving PLMN | M | | PLMN Identity | |
| | | | 9.3.3.5 | |
| Equivalent PLMNs | | 0..<maxnoofEPLMNs> | | Allowed PLMNs in addition to |
| | | | | Serving PLMN. |
| | | | | This list corresponds to the list of |
| | | | | “equivalent PLMNs” as defined in |
| | | | | TS 24.501 [26]. |
| | | | | This list is part of the roaming |
| | | | | restriction information. Roaming |
| | | | | restrictions apply to PLMNs other |
| | | | | than the Serving PLMN and |
| | | | | Equivalent PLMNs. |
| >PLMN Identity | M | | 9.3.3.5 | |
| RAT Restrictions | | 0..<maxnoofEPLMNsPlusOne> | | This IE contains RAT restriction |
| | | | | related information as specified |
| | | | | in TS 23.501 [9]. |
| >PLMN Identity | M | | 9.3.3.5 | |
| >RAT Restriction | M | | BIT STRING { | Each position in the bitmap |
| Information | | | e-UTRA (0), | represents a RAT. |
| | | | nR (1) } | If a bit is set to “1”, the respective |
| | | | (SIZE(8, ...)) | RAT is restricted for the UE. |
| | | | | If a bit is set to “0”, the respective |
| | | | | RAT is not restricted for the UE. |
| | | | | This version of the specification |
| | | | | does not use bits 2-7, the |
| | | | | sending node shall set bits 2-7 to |
| | | | | “0”, the receiving node shall |
| | | | | ignore bits 2-7. |
| Forbidden Area | | 0..<maxnoofEPLMNsPlusOne> | | This IE contains Forbidden Area |
| Information | | | | information as specified in TS |
| | | | | 23.501 [9]. |
| >PLMN Identity | M | | 9.3.3.5 | |
| >Forbidden TACs | | 1..<maxnoofForbTACs> | | |
| >>TAC | M | | 9.3.3.10 | The TAC of the forbidden TAI. |
| Service Area Information | | 0..<maxnoofEPLMNsPlusOne> | | This IE contains Service Area |
| | | | | Restriction information as |
| | | | | specified in TS 23.501 [9]. |
| >PLMN Identity | M | | 9.3.3.5 | |
| >Allowed TACs | | 0..<maxnoofAllowedAreas> | | |
| >>TAC | M | | 9.3.3.10 | The TAC of the allowed TAI. |
| >Not Allowed TACs | | 0..<maxnoofAllowedAreas> | | |
| >>TAC | M | | 9.3.3.10 | The TAC of the not-allowed TAI. |
| Access Restriction Info | | 0..<maxNo> | | This in |
| > Geographical info | | | | |
| > height. | | | | |

TABLE 9

| Range bound | Explanation |
|---|---|
| maxnoofEPLMNs | Maximum no. of equivalent PLMNs. Value |
| | is 15. |
| maxnoofEPLMNsPlusOne | Maximum no. of allowed PLMNs. Value |
| | is 16. |
| maxnoofForbTACs | Maximum no. of forbidden Tracking Area |
| | Codes. Value is 4096. |
| maxnoofAllowedAreas | Maximum no. of allowed or not allowed |
| | Tracking Areas. Value is 16. |

### Embodiment 2

In Embodiment 1, the present disclosure proposed a method for providing differentiated services for each UE. In addition, Embodiment 2 proposes a method for accurately determining a difference in resources of a communication services that are different depending on a location of a UE, and charging each user correctly.

To this end, in the present disclosure, when signaling to the core network, the wireless network measures the amount of radio resources or data transmission amount used in each criterion in each UE according to predetermined criteria, and included the measured amount in the signaling.

For example, the wireless network may inform the core network of information on the amount of data transmitted according to the height of each UE.

For example, when the UE transitions from the connected mode to the idle to delete the context of the UE, the wireless network can transmit information on the amount of data transmitted and received by the UE at each height/location to the core network.

9.1.4.1 Initial Context Setup Request

This message is sent by the MME to request the setup of a UE context.

Direction: MME→eNB

Tables 10 and 11 show an example of an initial context setup request to which the present disclosure can be applied.

TABLE 10

| | | | 4. IE type | | | |
|---|---|---|---|---|---|---|
| 1. IE/Group | | | and | 5. Semantics | 6. Criti- | 7. Assigned |
| Name | 2. Presence | 3. Range | reference | description | cality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate | M | | 9.2.1.20 | | YES | reject |
| Maximum Bit Rate | | | | | | |
| E-RAB to Be | | 1 | | | YES | reject |
| Setup List | | | | | | |
| >E-RAB to Be Setup | | 1 .. | | | EACH | reject |
| Item lEs | | <maxnoofE-RABs> | | | | |
| >>E-RAB ID | M | | 9.2.1.2 | | — | |
| >>E-RAB Level QoS | M | | 9.2.1.15 | Includes | — | |
| Parameters | | | | necessary | | |
| | | | | QoS | | |
| | | | | parameters. | | |
| >>Transport Layer | M | | 9.2.2.1 | | — | |
| Address | | | | | | |
| >>GTP-TEID | M | | 9.2.2.2 | | — | |
| >>NAS-PDU | ∘ | | 9.2.3 5 | | — | |
| >>Correlation ID | ∘ | | 9.2.1.80 | | YES | ignore |
| >>SIPTO | ∘ | | Correlation | | YES | ignore |
| Correlation ID | | | ID | | | |
| | | | 9.2.1.80 | | | |
| >>Bearer Type | ∘ | | 9.2.1.116 | | YES | reject |
| UE Security | M | | 9.2.1.40 | | YES | reject |
| Capabilities | | | | | | |
| Security Key | M | | 9.2.1.41 | The KeNB | YES | reject |
| | | | | is provided | | |
| | | | | after the | | |
| | | | | key-generation | | |
| | | | | in the | | |
| | | | | MME, see | | |
| | | | | TS 33.401 | | |
| | | | | [15]. | | |
| Trace Activation | ∘ | | 9.2.1.4 | | YES | ignore |
| Handover | ∘ | | 9.2.1.22 | | YES | ignore |
| Restriction List | | | | | | |
| UE Radio Capability | ∘ | | 9.2.1.27 | | YES | ignore |
| Subscriber Profile | ∘ | | 9.2.1.39 | | YES | ignore |
| ID for | | | | | | |
| RAT/Frequency | | | | | | |
| priority | | | | | | |
| CS Fallback | ∘ | | 9.2.3.21 | | YES | reject |
| Indicator | | | | | | |
| SRVCC Operation | ∘ | | 9.2.1.58 | | YES | ignore |
| Possible | | | | | | |
| CSG Membership | ∘ | | 9.2.1.73 | | YES | ignore |
| Status | | | | | | |
| Registered LAI | ∘ | | 9.2.3.1 | | YES | ignore |
| GUMMEI | ∘ | | 9.2.3.9 | This IE | YES | ignore |
| | | | | indicates | | |
| | | | | the MME | | |
| | | | | serving the | | |
| | | | | UE. | | |
| MME UE S1AP | ∘ | | 9.2.3.3 | This IE | YES | ignore |
| ID 2 | | | | indicates | | |
| | | | | the MME | | |
| | | | | UE S1AP | | |
| | | | | ID assigned | | |
| | | | | by the | | |
| | | | | MME. | | |
| Management Based | ∘ | | 9.2.1.83 | | YES | ignore |
| MDT Allowed | | | | | | |
| Management Based | ∘ | | MDT | | YES | ignore |
| MDT PLMN List | | | PLMN | | | |
| | | | List | | | |
| | | | 9.2.1.89 | | | |
| Additional CS | C-ifC | | 9.2.3.37 | | YES | ignore |
| Fallback Indicator | SFB | | | | | |
| | highpriority | | | | | |
| Masked IMEISV | ∘ | | 9.2.3.38 | | YES | ignore |
| Expected UE | ∘ | | 9.2.1.96 | | YES | ignore |
| Behaviour | | | | | | |
| ProSe Authorized | ∘ | | 9.2.1.99 | | YES | ignore |
| UE User Plane | ∘ | | 9.2.1.113 | | YES | ignore |
| CIoT Support | | | | | | |
| Indicator | | | | | | |
| V2X Services | ∘ | | 9.2.1.120 | | YES | ignore |
| Authorized | | | | | | |
| UE Sidelink | ∘ | | 9.2.1.122 | This IE | YES | ignore |
| Aggregate | | | | applies only | | |
| Maximum Bit Rate | | | | if the UE is | | |
| | | | | authorized | | |
| | | | | for V2X | | |
| | | | | services. | | |
| Enhanced | ∘ | | 9.2.1.123 | | YES | ignore |
| Coverage | | | | | | |
| Restricted | | | | | | |
| NR UE Security | ∘ | | 9.2.1.127 | | YES | ignore |
| Capabilities | | | | | | |
| CE-mode-B | ∘ | | 9.2.1.129 | | YES | ignore |
| Restricted | | | | | | |
| Aerial UE | ∘ | | 9.2.1.136 | | YES | ignore |
| subscription | | | | | | |
| information | | | | | | |
| Pending Data | ∘ | | 9.2.3.55 | | YES | ignore |
| Indication | | | | | | |
| Subscription Based | ∘ | | 9.2.1.140 | | YES | ignore |
| UE Differentiation | | | | | | |
| Information | | | | | | |
| Area description | | | 9.2.1.Y | | | |

TABLE 11

| 8. Range bound | 9. Explanation |
|---|---|
| maxnoofE-RABs | Maximum no. of E-RAB allowed towards |
| | one UE, the maximum value is 256. |

9.2.1.Y Area Description

This IE provides information on the amount of resource or data amount per area.

Table 12 shows an example of an area description to which the present disclosure can be applied.

TABLE 12

| | | | 13. IE type | | | |
|---|---|---|---|---|---|---|
| 10. IE/Group | | | and | 14. Semantics | 15. Criti- | 16. Assigned |
| Name | 11. Presence | 12. Range | reference | description | cality | Criticality |
| Area Info | | 1> | | | EACH | ignore |
| >Area Id | M | | 9.2.1.X | ID of Area | — | — |
| >>area | M | | OCTET | Information | — | — |
| description | | | STRING | describing area. | | |
| | | | (SIZE(4)) | E.g. geographical | | |
| | | | | coordinate. 3D | | |
| | | | | info. Height. etc | | |

9.1.4.7 UE Context Release Complete

This message is sent by the eNB to confirm the release of the UE-associated S1-logical connection over the S1 interface.

Direction: eNB→MME

Table 13 shows an example of UE CONTEXT RELEASE COMPLETE to which the present disclosure can be applied.

TABLE 13

| | | | | | | |
|---|---|---|---|---|---|---|
| | | | 20. IE type | | | |
| 17. IE/Group | | | and | 21. Semantics | 22. Criti- | 23. Assigned |
| Name | 18. Presence | 19. Range | reference | description | cality | Criticality |

| | | | | |
|---|---|---|---|---|
| Message Type | M | 9.2.1.1 | YES | reject |
| MME UE S1AP ID | M | 9.2.3.3 | YES | ignore |
| eNB UE S1AP ID | M | 9.2.3.4 | YES | ignore |
| Criticality | ∘ | 9.2.1.21 | YES | ignore |
| Diagnostics | | | | |
| User Location | ∘ | 9.2.1.93 | YES | ignore |
| Information | | | | |
| Information on | ∘ | 9.2.1.105 | YES | ignore |
| Recommended | | | | |
| Cells and eNBs | | | | |
| for Paging | | | | |
| Cell Identifier | ∘ | 9.2.1.109 | YES | ignore |
| and Coverage | | | | |
| Enhancement Level | | | | |
| Secondary RAT | ∘ | 9.2.1.124 | Yes | ignore |
| Usage Report List | | | | |
| Per Area data | | 9.2.1.X | | |
| amount report | | | | |

9.2.1.X Per Area Data Amount Report

This IE Provides Information on the Amount of Resource or Data Amount per Area.

Table 14 shows an example of Per Area Data amount report to which the present disclosure can be applied.

TABLE 14

| | | | 27. IE type | | | |
|---|---|---|---|---|---|---|
| 24. IE/Group | | | and | 28. Semantics | 29. Criti- | 30. Assigned |
| Name | 25. Presence | 26. Range | reference | description | cality | Criticality |
| Per Area | | 1> | | | EACH | ignore |
| reporting | | | | | | |
| >>Area Info | M | | 9.2.1.X | Area ID or area | — | — |
| | | | | description. E.g | | |
| | | | | height | | |
| >>>Start timestamp | M | | OCTET | Start time | — | — |
| timestamp | | | STRING | | | |
| | | | (SIZE(4)) | | | |
| >>>End | M | | OCTET | End time | — | — |
| timestamp | | | STRING | | | |
| | | | (SIZE(4)) | | | |
| >>>Usage count | M | | INTEGER | The unit is: | — | — |
| UL | | | (0..2⁶⁴-1) | octets | | |
| >>>Usage count | M | | INTEGER | The unit is: | — | — |
| DL | | | (0..2⁶⁴-1) | octets | | |

In addition, the MME/AMF, etc., receiving the above information may additionally transmit the information to the PCRF/OCF or the like through S-GW/P-GW/SMF, and support accurate charging through this. For example, the GTP protocol can be extended as follows.

Table 15 shows an example of information element types of GTPv2 to which the present disclosure can be applied.

TABLE 15

| IE Type | | | |
|---|---|---|---|
| value | | | |
| (Decimal) | Information elements | Comment/Reference | Number of Fixed Octets |
| 0 | Reserved | | |
| 1 | International Mobile Subscriber Identity (IMSI) | Variable Length/8.3 | Not Applicable |
| 2 | Cause | Variable Length/8.4 | Not Applicable |
| 3 | Recovery (Restart Counter) | Variable Length/8.5 | Not Applicable |
| 4 to 34 | Reserved for S101 interface | See 3GPP TS 29.276 [14] | See 3GPP TS 29.276 [14] |
| 35 to 50 | Reserved for S121 interface | See 3GPP TS 29.276 [14] | See 3GPP TS 29.276 [14] |
| 51 | STN-SR | See 3GPP TS 29.280 [15] | See 3GPP TS 29.280 [15] |
| 52 to 70 | Reserved for Sv interface | See 3GPP TS 29.280 [15] | See 3GPP TS 29.280 [15] |
| 71 | Access Point Name (APN) | Variable Length/8.6 | Not Applicable |
| 72 | Aggregate Maximum Bit Rate (AMBR) | Fixed Length/8.7 | 8 |
| 73 | EPS Bearer ID (EBI) | Extendable/8.8 | 1 |
| 74 | IP Address | Variable Length/8.9 | Not Applicable |
| 75 | Mobile Equipment Identity (MEI) | Variable Length/8.10 | Not Applicable |
| 76 | MSISDN | Variable Length/8.11 | Not Applicable |
| 77 | Indication | Extendable/8.12 | 2 |
| 78 | Protocol Configuration Options (PCO) | Variable Length/8.13 | Not Applicable |
| 79 | PDN Address Allocation (PAA) | Variable Length/8.14 | Not Applicable |
| 80 | Bearer Level Quality of Service (Bearer QoS) | Extendable/8.15 | 22 |
| 81 | Flow Quality of Service (Flow QoS) | Extendable/8.16 | 21 |
| 82 | RAT Type | Extendable/8.17 | 1 |
| 83 | Serving Network | Extendable/8.18 | 3 |
| 84 | EPS Bearer Level Traffic Flow Template (Bearer | Variable Length/8.19 | Not Applicable |
| | TFT) | | |
| 85 | Traffic Aggregation Description (TAD) | Variable Length/8.20 | Not Applicable |
| 86 | User Location Information (ULI) | Extendable/8.21 | “f + 4 − 4” (See FIG. 8.21-1) |
| 87 | Fully Qualified Tunnel Endpoint Identifier (F-TEID) | Extendable/8.22 | 9/21/25 |
| 88 | TMSI | Variable Length/8.23 | Not Applicable |
| 89 | Global CN-Id | Variable Length/8.24 | Not Applicable |
| 90 | S103 PDN Data Forwarding Info (S103PDF) | Variable Length/8.25 | Not Applicable |
| 91 | S1-U Data Forwarding Info (S1UDF) | Variable Length/8.26 | Not Applicable |
| 92 | Delay Value | Extendable/8.27 | 1 |
| 93 | Bearer Context | Extendable/8.28 | Not Applicable |
| 94 | Charging ID | Extendable/8.29 | 4 |
| 95 | Charging Characteristics | Extendable/8.30 | 2 |
| 96 | Trace Information | Variable Length/8.31 | Not Applicable |
| 97 | Bearer Flags | Extendable/8.32 | 1 |
| 98 | Reserved | | |
| 99 | PDN Type | Extendable/8.34 | 1 |
| 100 | Procedure Transaction ID | Extendable/8.35 | 1 |
| 101 | Reserved | | |
| 102 | Reserved | | |
| 103 | MM Context (GSM Key and Triplets) | Extendable/8.38 | “r + 1 − 4” (See FIG. 8.38-1) |
| 104 | MM Context (UMTS Key, Used Cipher and | Extendable/8.38 | “r + 1 − 4” (See FIG. 8.38-2) |
| | Quintuplets) | | |
| 105 | MM Context (GSM Key, Used Cipher and | Extendable/8.38 | “r + 1 − 4” (See FIG. 8.38-3) |
| | Quintuplets) | | |
| 106 | MM Context (UMTS Key and Quintuplets) | Extendable/8.38 | “r + 1 − 4” (See FIG. 8.38-4) |
| 107 | MM Context (EPS Security Context, Quadruplets | Extendable/8.38 | “s + 64 − 4” (See FIG. 8.38-5) |
| | and Quintuplets) | | |
| 108 | MM Context (UMTS Key, Quadruplets and | Extendable/8.38 | “r + 1 − 4” (See FIG. 8.38-6) |
| | Quintuplets) | | |
| 109 | PDN Connection | Extendable/8.39 | Not Applicable |
| 110 | PDU Numbers | Extendable/8.40 | 9 |
| 111 | P-TMSI | Variable Length/8.41 | Not Applicable |
| 112 | P-TMSI Signature | Variable Length/8.42 | Not Applicable |
| 113 | Hop Counter | Extendable/8.43 | 1 |
| 114 | UE Time Zone | Extendable/8.44 | 2 |
| 115 | Trace Reference | Fixed Length/8.45 | 6 |
| 116 | Complete Request Message | Variable Length/8.46 | Not Applicable |
| 117 | GUTI | Variable Length/8.47 | Not Applicable |
| 118 | F-Container | Variable Length/8.48 | Not Applicable |
| 119 | F-Cause | Variable Length/8.49 | Not Applicable |
| 120 | PLMN ID | Variable Length/8.50 | Not Applicable |
| 121 | Target Identification | Variable Length/8.51 | Not Applicable |
| 122 | Reserved | | |
| 123 | Packet Flow ID | Variable Length/8.53 | Not Applicable |
| 124 | RAB Context | Fixed Length/8.54 | 9 |
| 125 | Source RNC PDCP Context Info | Variable Length/8.55 | Not Applicable |
| 126 | Port Number | Extendable/8.56 | 2 |
| 127 | APN Restriction | Extendable/8.57 | 1 |
| 128 | Selection Mode | Extendable/8.58 | 1 |
| 129 | Source Identification | Variable Length/8.59 | Not Applicable |
| 130 | Reserved | | |
| 131 | Change Reporting Action | Variable Length/8.61 | Not Applicable |
| 132 | Fully Qualified PDN Connection Set Identifier | Extendable/8.62 | “q + 1 − 4” (See FIG. 8.62-1) |
| | (FQ-CSID) | | |
| 133 | Channel needed | Variable Length/8.63 | Not Applicable |
| 134 | eMLPP Priority | Variable Length/8.64 | Not Applicable |
| 135 | Node Type | Extendable/8.65 | 1 |
| 136 | Fully Qualified Domain Name (FQDN) | Variable Length/8.66 | Not Applicable |
| 137 | Transaction Identifier (TI) | Variable Length/8.68 | Not Applicable |
| 138 | MBMS Session Duration | Extendable/8.69 | 3 |
| 139 | MBMS Service Area | Variable Length/8.70 | Not Applicable |
| 140 | MBMS Session Identifier | Extendable/8.71 | 1 |
| 141 | MBMS Flow Identifier | Extendable/8.72 | 2 |
| 142 | MBMS IP Multicast Distribution | Extendable/8.73 | “m + 1 − 4” (See FIG. 8.73-1) |
| 143 | MBMS Distribution Acknowledge | Extendable/8.74 | 1 |
| 144 | RFSP Index | Fixed Length/8.77 | 2 |
| 145 | User CSG Information (UCI) | Extendable/8.75 | 8 |
| 146 | CSG Information Reporting Action | Extendable/8.76 | 1 |
| 147 | CSG ID | Extendable/8.78 | 4 |
| 148 | CSG Membership Indication (CMI) | Extendable/8.79 | 1 |
| 149 | Service indicator | Fixed Length/8.80 | 1 |
| 150 | Detach Type | Fixed Length/8.81 | 1 |
| 151 | Local Distiguished Name (LDN) | Variable Length/8.82 | Not Applicable |
| 152 | Node Features | Extendable/8.83 | 1 |
| 153 | MBMS Time to Data Transfer | Extendable/8.84 | 1 |
| 154 | Throttling | Extendable/8.85 | 2 |
| 155 | Allocation/Retention Priority (ARP) | Extendable/8.86 | 1 |
| 156 | EPC Timer | Extendable/8.87 | 1 |
| 157 | Signalling Priority Indication | Extendable/8.88 | 1 |
| 158 | Temporary Mobile Group Identity (TMGI) | Extendable/8.89 | 6 |
| 159 | Additional MM context for SRVCC | Extendable/8.90 | “e − 4” (See FIG. 8.90-1) |
| 160 | Additional flags for SRVCC | Extendable/8.91 | 1 |
| 161 | Reserved | | |
| 162 | MDT Configuration | Extendable/8.93 | “q − 4” (See FIG. 8.93-1) |
| 163 | Additional Protocol Configuration Options (APCO) | Extendable/8.94 | “m − 4” (See FIG. 8.94-1) |
| 164 | Absolute Time of MBMS Data Transfer | Extendable/8.95 | 8 |
| 165 | H(e)NB Information Reporting | Extendable/8.96 | 1 |
| 166 | IPv4 Configuration Parameters (IP4CP) | Extendable/8.97 | 5 |
| 167 | Change to Report Flags | Extendable/8.98 | 1 |
| 168 | Action Indication | Extendable/8.99 | 1 |
| 169 | TWAN Identifier | Extendable/8.100 | “k + 6 − 4” (See FIG. 8.100-1) |
| 170 | ULI Timestamp | Extendable/8.101 | 4 |
| 171 | MBMS Flags | Extendable/8.102 | 1 |
| 172 | RAN/NAS Cause | Extendable/8.103 | “m − 4” (See FIG. 8.103-1) |
| 173 | CN Operator Selection Entity | Extendable/8.104 | 1 |
| 174 | Trusted WLAN Mode Indication | Extendable/8.105 | 1 |
| 175 | Node Number | Extendable/8.106 | “p − 4” (See FIG. 8.106-1) |
| 176 | Node Identifier | Extendable/8.107 | “q − 4” (See FIG. 8.107-1) |
| 177 | Presence Reporting Area Action | Extendable/8.108 | “t − 4” (See FIG. 8.108-1) |
| 178 | Presence Reporting Area Information | Extendable/8.109 | 4 |
| 179 | TWAN Identifier Timestamp | Extendable/8.110 | 4 |
| 180 | Overload Control Information | Extendable/8.111 | Not Applicable |
| 181 | Load Control Information | Extendable/8.112 | Not Applicable |
| 182 | Metric | Fixed Length/8.113 | 1 |
| 183 | Sequence Number | Fixed Length/8.114 | 4 |
| 184 | APN and Relative Capacity | Extendable/8.115 | “m − 4” (See FIG. 8.115 |
| 185 | WLAN Offloadability Indication | Extendable/8.116 | 1 |
| 186 | Paging and Service Information | Extendable/8.117 | m − 4 (See FIG. 8.117-1) |
| 187 | Integer Number | Variable/8.118 | Not Applicable |
| 188 | Millisecond Time Stamp | Extendable/8.119 | 6 |
| 189 | Monitoring Event Information | Extendable/8.120 | “k + 2 − 4” (See FIG. 8.120-1) |
| 190 | ECGI List | Extendable/8.121 | “m*7 + 2” (See FIG. 8.121-1) |
| 191 | Remote UE Context | Extendable/8.122 | Not Applicable |
| 192 | Remote User ID | Extendable/8.123 | “c − 4” (see FIG. 8.123-1) |
| 193 | Remote UE IP information | Variable Length/8.124 | Not Applicable |
| 194 | CIoT Optimizations Support Indication | Extendable/8.125 | 1 |
| 195 | SCEF PDN Connection | Extendable/8.126 | Not Applicable |
| 196 | Header Compression Configuration | Extendable/8.127 | 4 |
| 197 | Extended Protocol Configuration Options (ePCO) | Variable Length/8.128 | Not Applicable |
| 198 | Serving PLMN Rate Control | Extendable/8.129 | 4 |
| 199 | Counter | Extendable/8.130 | 5 |
| 200 | Mapped UE Usage Type | Extendable/8.131 | 2 |
| 201 | Secondary RAT Usage Data Report | Extendable/8.132 | 27 |
| 202 | UP Function Selection Indication Flags | Extendable/8.133 | 1 |
| 203 | Maximum Packet Loss Rate | Extendable/8.134 | 1 |
| 204 | APN Rate Control Status | Extendable/8.135 | 20 |
| 205 | Extended Trace Information | Extendable/8.136 | “r − 4” (see FIG. 8.136-1) |
| 2XY | Per Area data amount report | | |
| 206 to 253 | Spare. For future use. | | |
| 254 | Special IE type for IE Type Extension | See NOTE 2 | Not Applicable |
| 255 | Private Extension | Variable Length/8.67 | Not Applicable |
| 256 to 65535 | Spare. For future use. | | |

NOTE 1:
The size of the TLI (Type, Length and Instance) fields, i.e “4” octets, has been subtracted from the number of the fixed octets of the “Fixed Length” and “Extendable” IEs. Hence for some of the “Extendable” IEs, for which the length is defined in terms of variable number of octets, “4” is explicitly subtracted while defining the fixed number of octets. E.g. Length of User Location Information is defined as “f + 4” and fixed number of octets for the same is defined as “f + 4 − 4”.
NOTE 2:
The IE Type value 254 indicates that the IE Type shall be further identified by an IE Type Extension field; see subclause 8.2.1A. A GTP-C entity which does not support any IE Type encoded with an IE Type Extension field shall ignore an IE received with the IE Type value 254.

### Embodiment 3

As described above, the present disclosure illustrates a method for blocking data connection according to the location of the UE. However, depending on the characteristics of the UE, it may not be preferable that the network suddenly cuts off communication with the UE. For example, when the drone is controlled via cellular communication, if the communication is suddenly cut off, the drone can no longer be controlled remotely, which can lead to a bigger accident.

Accordingly, in order to solve this problem, the present disclosure illustrates a method for informing a UE in advance of a case in which a network should cut off communication with any UE, and allowing the UE to take an operation based thereon.

For example, the operation in Embodiment 1 may be modified as follows.

The UE A and the UE B subscribe to MNO C. As the subscription condition, the UE A may be subscribed to receive a service up to a low altitude (50 m), for example, and the UE B may be subscribed to receive a service up to a medium altitude (400 m), for example.

Both the UE A and the UE B are on the ground and start data communication. That is, both the UE A and the UE B transition from the idle mode to the connected mode, the core network transfers service restriction information on each UE to the wireless network.

Both the UE A and the UE B are loaded on drone and start to rise.

Both the UE A and the UE B reach 45 m altitude. The wireless network may determine that the UE continues to rise. In addition, if the UE continues to rise, since the UE is out of an area in which services can be provided to the UE, the wireless network can transmit, to the UE, warning information that the communication can be cut off. For example, the network may inform from which area the communication with the UE is cut off, or in which area the communication may be provided to the UE.

The notification is delivered to the UE A or the user designated by the UE A or the user associated with the UE A. For example, the information may be transferred to a coordinator of the drone.

The user who has received the information can stop the drone rising and lower the drone again in order to continue the communication to the UE A.

To this end, the present disclosure may define the following messages and operations.

UEWarningInformation

The UEWarningInformation message is used for the indication of possible release of connection toward the UE.

Signaling radio bearer: SRB1

RLC-SAP: AM

Logical channel: DCCH

Direction: Network to UE

Table 16 shows an example of a UEWarning information message to which the present disclosure can be applied.

TABLE 16
-- ASN1START
-- TAG-UEASSISTANCEIN FORMATION-START

| | |
|---|---|
| UEWarningInformation ::= | SEQUENCE { |

| | |
|---|---|
| criticalExtensions | CHOICE { |

ueWarningInformation

UEWarningInformation-IEs,

| | |
|---|---|
| criticalExtensionsFuture | SEQUENCE { } |

}

} |

| | |
|---|---|
| UEWarningInformation-IEs ::= | SEQUENCE { |

ConnectionReleseWarning

| | |
|---|---|
| ConnectionReleaseWarning | OPTIONAL, |

| | |
|---|---|
| lateNonCriticalExtension | OCTET STRING |

OPTIONAL,

| | |
|---|---|
| nonCriticalExtension | SEQUENCE { } |

OPTIONAL
}

| | |
|---|---|
| ConnectionReleaseWarning::= | CHOICE { |

| | |
|---|---|
| timeToRelease | ENUMERATED |

{1s, 10s, 20s },

| | |
|---|---|
| areaToRelease | geographicinfo, |

...

}

Table 17 shows an example of UEWarningInformation field descriptions to which the present disclosure can be applied.

TABLE 17
UEWarningInformation field descriptions

timeToRelease
Indicates how soon the connection may be released, e.g.
if UE continues to same movement.
areaToRelase
Indicates in which area the connection may be released.
This can be area info or height, location etc.

The UE receiving the information may transmit the information to the application/user, present the information by a sound, or display the information on a screen, so that the application/user can perform another operation. For example, the drone can stop the rising operation.

In the above operation, there may be a case where the location of the application/user and the location of the UE are different. For example, if a user accidentally drops a smartphone into a drone's loading box and does not recognize it, it is not meaningful to transmit a notification to the UE on the network. Therefore, in order to prevent this, the user may store another telephone number or contact information to be notified in the network in advance, and the network may make contact by the pre-stored number when transmitting warning information to the UE as described above. To this end, various methods such as SMS/machine voice call can be used.

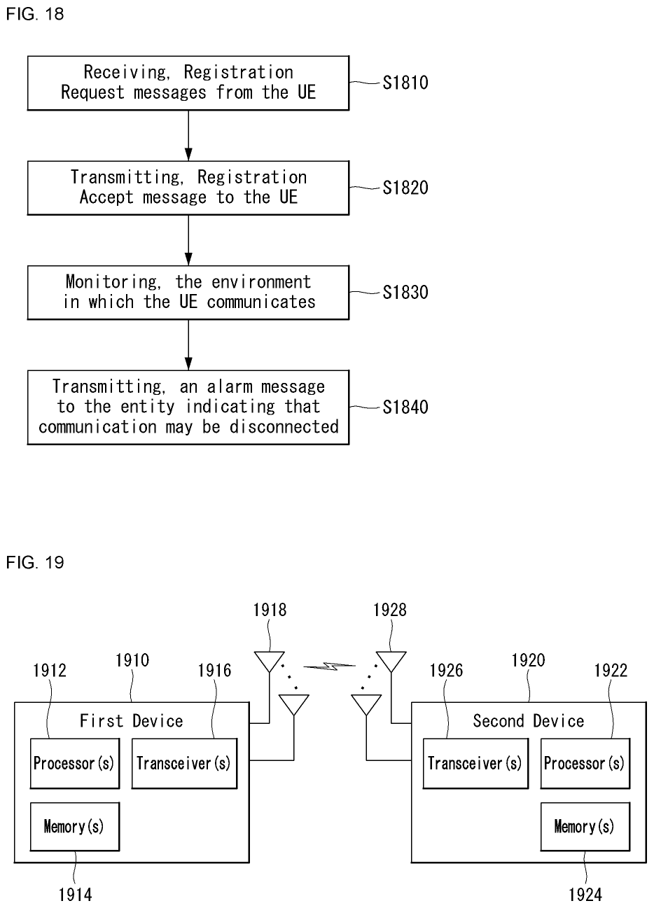

FIG. 18 illustrates an embodiment to which the present disclosure can be applied.

Referring to FIG. 18, an entity refers to a separate UE that can be accessed by the user of the UE so as to control the operation of the UE. The network may include RAN, CN, data base or network application. The UE or entity may have a registration status with the network through a registration procedure.

The user registers, in the network, a contact method (for example, SMS, phone call, application notification, etc.) associated with the entity or the UE, or contact information, through the entity (S1700). In addition, the user may register, in the network, the contact method (for example, SMS, phone call, application notification, etc.) associated with the entity or the UE, or the contact information, through the UE. For example, the contact method or the contact information may be a portal service or a call center provided through the network. For example, the contact method or the contact information may be included in the registration request message when the UE or the entity performs a registration procedure on the network. This is stored in a data base of the network.

The network checks whether the movement of the UE satisfies a predetermined condition (S1710). For example, the network may monitor whether the UE moves closer to a location where communication services cannot be provided to the UE.

The wireless network informs the core network that the satisfaction of the predefined conditions for the UE is imminent or the predetermined conditions for the UE are satisfied (S1720). For example, the wireless network may transmit information on the movement of the UE to the network, the movement to the restricted area, and the like.

The core network transmits the information received through the step S1720 to an application or a network which is previously designated or configured for each UE (S1730).

The application or the network acquires the information on the UE (S1740). For example, the contact method and the like associated with the entity or the UE may be checked.

The application or the network notifies the entity of the restriction information based on the obtained information through step S1740 (S1750). In addition, the application or the network may notify the entity of the restriction information through the UE. For example, the notification message may include information that the communication is cut off when the UE continues the current movement or that the UE is approaching a dead area.

The user may perform an operation of readjusting the movement of the UE through the entity (S1760). For example, the information of the notification message may be checked by the user through the entity.

The entity transmits a control signal for controlling the movement of the UE to the UE (S1770). In more detail, such a control signal may be generated based on a setting value input by the user through the entity.

FIG. 18 illustrates an embodiment of the network to which the present disclosure can be applied.

Referring to FIG. 18, the network receives the registration request message from the UE (S1810). The registration request message may include contact information associated with an entity connected with the UE.

The network transmits a registration accept message to the UE as a response to the registration request message (S1820).

The network checks the environment in which the UE performs communication (S1830).

The network transmits, to the entity, an alarm message indicating that the connection with the UE may be released (S1840). In more detail, the network may transmit an alarm message based on the location where the UE performs communication and the configuration information of the UE stored in the network. For example, the configuration information of the UE may include the information on the restricted area in which the UE cannot perform communication or the contact information associated with the entity. In addition, such an alarm message may be transmitted when the location where the UE performs communication or the location where the UE is expected to perform communication corresponds to the restricted area where the UE cannot perform communication. In addition, the information on the restricted area in which the UE cannot perform communication may be set to be a value indicating a height or an altitude. In addition, the alarm message may include time information associated with the release of communication with the UE or information on the restricted area in which the UE cannot perform communication.

In the present disclosure, message names, message formats, names of information elements, formats of information elements and the like are exemplified. The names, the included locations, or the types of messages used can be variously applied and modified.

The present disclosure can be variously applied to a 5G system, a 4G system, or the like.

General devices to which the present disclosure can be applied

FIG. 19 illustrates a block configuration diagram of a communication device according to an embodiment of the present disclosure.

Referring to FIG. 19, the wireless communication system includes a network node 1910 and a plurality of terminals (UEs) 1920.

The network node 1910 includes a processor 1911, a memory 1912, and a communication module (transceiver) 1913. The processor 1911 implements the functions, the processes, and/or the methods described above with reference to in FIGS. 1 to 14. The layers of the wired/radio interface protocol may be implemented by the processor 1911.

The memory 1912 is connected to the processor 1911 and stores various information for driving the processor 1911. The communication module 1913 is connected to the processor 1911 and transmits and/or receives a wired/wireless signal. Examples of the network node 1910 may include a base station, an AMF, an SMF, a UDF, or the like. In particular, when the network node 1910 is the base station, the communication module 1913 may include a radio frequency unit (RF) for transmitting/receiving the wireless signal.

The terminal 1920 includes a processor 1921, a memory 1922, and a communication module (transceiver) 1923. The processor 1921 implements the functions, the processes, and/or the methods described above with reference to FIGS. 1 to 16. The layers of the radio interface protocol may be implemented by the processor 1921. In particular, the processor may include a NAS layer and an AS layer. The memory 1922 is connected to the processor 1921 and stores various information for driving the processor 1921. The communication module 1923 is connected to the processor 1921 and transmits and/or receives the wireless signal.

The memories 1912 and 1922 may be inside or outside the processors 1911 and 1921 and may be connected to the processors 1911 and 1921 by various well-known means. Also, the network node 1910 (in the case of the base station) and/or the terminal 1920 may include a single antenna or multiple antennas.

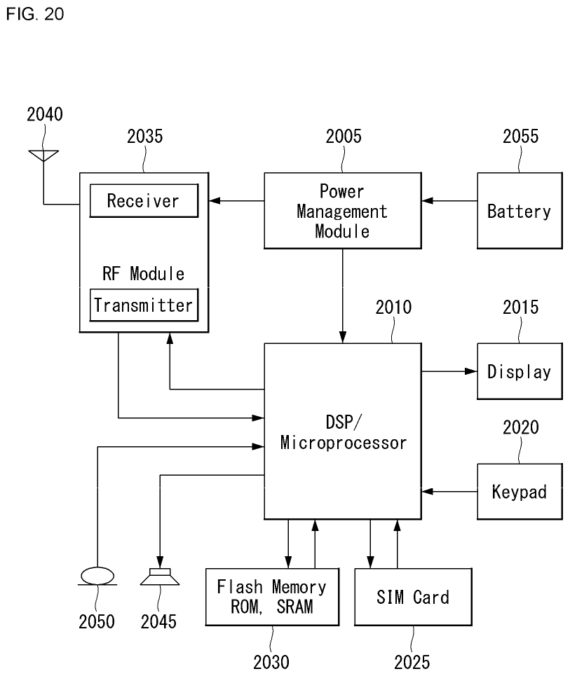

FIG. 20 illustrates a block configuration diagram of a communication device according to an embodiment of the present disclosure.

In particular, FIG. 20 is a diagram illustrating the terminal of FIG. 20 in more detail. The communication module illustrated in FIG. 19 includes an RF module (or RF unit) of FIG. 20. The processor illustrated in FIG. 19 corresponds to a processor (or a digital signal processor (DSP) 2010) in FIG. 20. The memory illustrated in FIG. 19 corresponds to a memory 2030 of FIG. 20.

Referring to FIG. 20, a terminal may be configured to include a processor (or a digital signal processor (DSP)) 2010, an RF module (or RF unit) 2035, a power management module 2005, an antenna 2040, a battery 2055, a display 2015, a keypad 2020, a memory 2030, a subscriber identification module (SIM) card 2025 (this configuration is optional), a speaker 2045, and a microphone 2050. The terminal may also include a single antenna or multiple antennas.

The processor 2010 implements the functions, the processes and/or the methods described above. The layers of the radio interface protocol may be implemented by the processor 2010.

The memory 2030 is connected to the processor 2010 and stores various information related to an operation of the processor 2010. The memory 2030 may be inside or outside the processors 2010 and 1921 and may be connected to the processor 2010 by various well-known means.

The user inputs command information such as a telephone number, for example, by pressing (or touching) a button on the keypad 2020 or by voice activation using the microphone 2050. The processor 2010 receives the command information and performs a proper function as placing a call by a phone number. Operational data may be extracted from the SIM card 2025 or the memory 2030. In addition, the processor 2010 may display command information or driving information on the display 2015 for the user to recognize and for convenience.

The RF unit 2035 is connected to the processor 2010 and transmits and/or receives an RF signal. The processor 2010 transmits command information to the RF module 2035 to transmit, for example, a wireless signal constituting voice communication data to initiate communication. The RF module 2035 includes a receiver and a transmitter for receiving and transmitting a wireless signal. The antenna 2040 functions to transmit and receive the wireless signal. When receiving the wireless signal, the RF module 2035 may transmit a signal and convert the signal into baseband to be processed by the processor 2010. The processed signal may be converted into audible or readable information output through the speaker 2045.

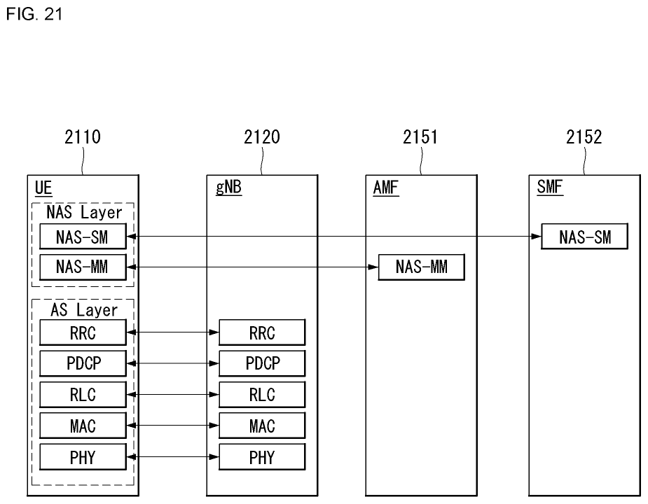

FIG. 21 illustrates a structure of a radio interface protocol in a control plane between a UE and eNodeB.

The radio interface protocol is based on the 3GPP radio access network standard. The radio interface protocol is composed of a physical layer (physical layer), a data link layer (data link layer) and a network layer (network layer) horizontally, and is vertically divided into a user plane for data information transmission and a control plane for signaling transmission.

The protocol layers are based on a lower three layers of a open system interconnection (OSI) reference model, which is widely known in communication systems, and may be divided into L1 (first layer), L2 (second layer), and L3 (third layer).

Hereinafter, each layer of the radio protocol of the control plane illustrated in FIG. 21 will be described.

The physical layer, which is the first layer, provides an information transfer service using a physical channel. The physical layer is connected to a medium access control layer on the upper side through a transport channel, and data between the medium access control layer and the physical layer is transmitted through the transport channel. In addition, data is transferred between different physical layers, that is, between physical layers of a transmitting side and a receiving side through a physical channel.

The physical channel is composed of several subframes on a time axis and several sub-carriers on a frequency axis. Here, one subframe is composed of a plurality of symbols and a plurality of subcarriers on the time axis. One subframe is composed of a plurality of resource blocks, and one resource block is composed of a plurality of symbols and a plurality of subcarriers. The transmission time interval (TTI), which is a unit time for transmitting data, is 1 ms corresponding to one subframe.

According to 3GPP LTE, the physical channels present in the physical layer of the transmitting side and the receiving side may be divided into a physical downlink shared channel (PDSCH) and a physical uplink shared channel (PUSCH) which are data channels, and a physical downlink control channel (PDCCH), a physical control format indicator channel (PCFICH), a physical hybrid-ARQ indicator channel (PHICH), and a physical uplink control channel (PUCCH) which are control channels.

The PCFICH transmitted in a first OFDM symbol of a subframe carries a control format indicator (CFI) regarding the number of OFDM symbols (that is, the size of the control region) used for transmission of control channels in the subframe. The wireless device first receives the CFI on the PCFICH and then monitors the PDCCH.

Unlike the PDCCH, the PCFICH does not use blind decoding and is transmitted on a fixed PCFICH resource of a subframe.

The PHICH carries a positive-acknowledgement (ACK)/negative-acknowledgement (NACK) signal for a UL hybrid automatic repeat request (HARQ). The ACK/NACK signal for uplink (UL) data on the PUSCH transmitted by the wireless device is transmitted on the PHICH.

The physical broadcast channel (PBCH) is transmitted in preceding four OFDM symbols of a second slot of a first subframe of the radio frame. The PBCH carries system information necessary for the wireless device to communicate with the base station, and the system information transmitted through the PBCH is called a master information block (MIB). In comparison, the system information transmitted on the PDSCH indicated by the PDCCH is called a system information block (SIB).

The PDCCH may carry resource allocation of an upper layer control message such as a resource allocation and transmission format of a downlink-shared channel (DL-SCH), resource allocation information of an uplink shared channel (UL-SCH), paging information on a PCH, system information on the DL-SCH, and a random access response transmitted on the PDSCH, an aggregation of transmission power control commands for individual UEs in a UE group, activation of a voice over internet protocol (VoIP), and the like. A plurality of PDCCHs may be transmitted in the control region, and the terminal may monitor the plurality of PDCCHs. The PDCCH is transmitted on an aggregation of one or several consecutive control channel elements (CCEs). The CCE is a logical allocation unit used to provide a PDCCH with a coding rate according to a state of a radio channel. The CCE corresponds to a plurality of resource element groups. The format of the PDCCH and the number of bits of the allowed PDCCH are determined according to the correlation between the number of CCEs and the coding rate provided by the CCEs.

The control information transmitted through the PDCCH is called downlink control information (DCI). The DCI may include the resource allocation (referred to as DL grant) of the PDSCH, the resource allocation (referred to as UL grant) of the PUSCH, and an aggregation of transmit power control commands for individual UEs in any UE group and/or activation of the voice over internet protocol (VoIP).

There are several layers in the second layer. First, a medium access control (MAC) layer is responsible for mapping various logical channels to various transport channels, and also for logical channel multiplexing to map multiple logical channels to one transport channel. The MAC layer is connected to an RLC layer as an upper layer by a logical channel, and the logical channel is largely divided into a control channel that transmits information of a control plane according to the type of information to be transmitted and a traffic channel that transmits user plane information.

A radio link control (RLC) layer of the second layer serves to adjust the data size so that the lower layer is suitable for transmitting data to the radio section by segmenting and concatenating data received from the upper layer. In addition, three operation modes of a transparent mode (TM), an un-acknowledged mode (UM) (non-response mode), and an acknowledged mode (AM) (response mode) are provided to ensure various QoS required by each radio bearer (RB). In particular, the AM RLC performs a retransmission function through an automatic repeat and request (ARQ) function for reliable data transmission.

A packet data convergence protocol (PDCP) layer of the second layer performs a header compression function of reducing an IP packet header size having a relatively larger size and unnecessary control information for efficient transmission in a radio section having a low bandwidth when transmitting IP packets such as IPv4 or IPv6. This transmits only the necessary information in the header portion of the data, thereby increasing the transmission efficiency of the radio section. In addition, in the LTE system, the PDCP layer also performs a security function, which is composed of encryption (Ciphering) for preventing third-party data interception and integrity protection for preventing third-party data manipulation.

The radio resource control layer (hereinafter abbreviated as RRC) layer located at the top of the third layer is defined only in the control plane, and serves to control the logical channels, the transport channels, and the physical channels in connection with the setting, resetting, and release of the radio bearers (abbreviated as RB). In this case, the RB means a service provided by the second layer for data transmission between the terminal and the E-UTRAN.

If there is an RRC connection (RRC connection) between the RRC of the terminal and the RRC layer of the radio network, the terminal is in the RRC connected state (connected mode), and otherwise, the terminal is in the RRC idle state (Idle mode).

Hereinafter, the RRC state and the RRC connection method of the UE will be described. The RRC state refers to whether or not the RRC of the terminal is logically connected with the RRC of the E-UTRAN. The case where the RRC of the terminal is logically connected with the RRC of the E-UTRAN is referred to as the RRC_CONNECTED state, and the case where the RRC of the terminal is not logically connected with the RRC of the E-UTRAN is referred to as the RRC_IDLE state. Since the terminal in the RRC_CONNECTED state has an RRC connection, the E-UTRAN can detect the existence of the corresponding terminal in units of cells, thereby effectively controlling the terminal. On the other hand, the terminal in the RRC_IDLE state cannot detect the existence of the terminal by the E-UTRAN, and manages the core network in a tracking area (TA) unit which is a larger area unit than the cell. That is, the terminal in the RRC_IDLE state only detects whether the terminal exists in a larger area than the cell, and the terminal needs to transition to the RRC_CONNECTED state in order to receive a normal mobile communication service such as voice or data. Each TA is identified by a tracking area identity (TAI). The terminal may configure a TAI through a tracking area code (TAC), which is information broadcast in a cell.

When the user first turns on the power of the terminal, the terminal first searches for an appropriate cell, then establishes an RRC connection in the cell, and registers the terminal's information in the core network. Thereafter, the terminal stays in the RRC_IDLE state. The terminal staying in the RRC_IDLE state (re) selects a cell as needed and looks at system information or paging information. This is called camping on the cell. When it is necessary to establish an RRC connection, the terminal staying in the RRC_IDLE state makes an RRC connection with the RRC of the E-UTRAN through an RRC connection procedure and transitions to the RRC_CONNECTED state. There are several cases in which the terminal in the RRC_IDLE state needs to establish the RRC connection. For example, when an uplink data transmission is necessary due to a user's call attempt, or when the paging signal is received from the E-UTRAN, there may be a response message transmission thereto, and the like.

The non-access stratum (NAS) layer performs functions such as session management and mobility management.

The following describes the NAS layer shown in FIG. 21 in detail.

The NAS layer is divided into a NAS entity for mobility management (MM) and a NAS entity for session management (SM).

1) The NAS entity for MM provides the following general functions.

The NAS procedure associated with the AMF includes the followings.

Registration management and access management procedure. The AMF supports the following functions.

NAS signal connection (integrity protection, encryption) between the UE and the AMF

2) The NAS entity for the SM performs the session management between the UE and the SMF.

The SM signaling message are processed, i.e., generated and processed, at the NAS-SM layer of the UE and the SMF. The content of the SM signaling message is not interpreted by the AMF.

For the SM signaling transmission

The NAS entity for the MM generates a security header indicating the NAS transmission of SM signaling and a NAS-MM message that guides a method and a location for transferring an SM signaling message through additional information on the received NAS-MM.

Upon receiving the SM signaling, the NAS entity for the SM performs an integrity check of the NAS-MM message and a method and a location for interpreting additional information to derive an SM signaling message.

Meanwhile, in FIG. 21, the RRC layer, the RLC layer, the MAC layer, and the PHY layer located under the NAS layer are collectively referred to as an access stratum (AS).

In the present disclosure, a wireless device includes a base station, a network node, a transmitting terminal, a receiving terminal, a wireless device, a wireless communication device, a vehicle, a vehicle equipped with a self-driving function, an unmanned aerial vehicle (UAV), an artificial intelligence (AI) module, a robot, an augmented reality (AR) device, a virtual reality (VR) device, an MTC device, an IoT device, a medical device, a fintech device (or financial device), a security device, a climate/environmental device, or other fourth-order industrial revolution fields, devices associated with a 5G service, or the like. For example, the drone can be a vehicle flying by radio control signals without people. For example, the MTC device and the IoT device are devices that do not require human intervention or manipulation, and may be a smart meter, a bending machine, a thermometer, a smart bulb, a door lock, various sensors, and the like. For example, the medical device is a device used to examine, replace, or modify a device, a structure, or a function used for diagnosing, treating, alleviating, treating, or preventing a disease, and may be a medical device, a surgical device, a (in vitro) diagnostic device, a hearing aid, a surgical operation device, and the like. For example, the security device is a device installed to prevent a risk that may occur and maintain safety, and may be a camera, a CCTV, a black box, or the like. For example, the fintech device is a device that can provide financial services such as mobile payment, and may be a payment device or a point of sales (POS). For example, the climate/environmental device may mean a device for monitoring and predicting the climate/environment.

The mobile terminal described in the present disclosure may include a mobile phone, a smart phones, a laptop computer, a digital broadcasting terminal, personal digital assistants (PDA), a portable multimedia player, navigation, a slate PC, a tablet PC, an ultrabook, a wearable device (e.g., smartwatch, smart glass, head mounted display), and the like. Furthermore, the mobile device may be used for controlling at least one device in an IoT (Internet of Things) environment or a smart greenhouse.

However, those skilled in the art can easily understand that the configuration according to the embodiment described in the present disclosure may also apply to the fixed terminal such as digital TV, desktop computer, digital signage, etc., except that the case where it is applied only to the mobile terminal.

In the above, embodiments associated with the control method that can be implemented in the mobile terminal configured as described above have been described with reference to the accompanying drawings. It will be apparent to those skilled in the art that the present disclosure may be embodied in other specific forms without departing from the spirit and essential characteristics of the present disclosure.

Embodiments of the present disclosure described above may be implemented through various means. For example, embodiments of the present disclosure may be implemented by hardware, firmware, software, a combination thereof, or the like.

In the case in which the embodiment of the present disclosure is implemented by the hardware, the method according to the embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of implementation by firmware or software, the method according to the embodiments of the present disclosure may be implemented in the form of an apparatus, a procedure, a function, or the like for performing the functions or operations described above. A software code may be stored in a memory unit and be driven by a processor. The memory unit may be positioned inside or outside the processor and transmit and receive data to and from the processor by various well-known means.

The present disclosure described above permits the program to be embodied as computer readable code on a medium on which the program is recorded. A computer readable medium may include all kinds of recording devices in which data that may be read by a computer system are stored. An example of the computer readable medium may include a hard disk drive (HDD), a solid state disk (SSD), a silicon disk drive (SDD), an ROM, an RAM, a CD-ROM, a magnetic tape, a floppy disk, a floppy disk, an optical data storage device, or the like, and also include media implemented in a form of a carrier wave (for example, transmission through the Internet). In addition, the computer may also include a processor Y120 of the terminal. Therefore, the above-mentioned detailed description is to be interpreted as being illustrative rather than being restrictive in all aspects. The scope of the present disclosure should be determined by reasonable interpretation of the appended claims, and all changes within the equivalent scope of the present disclosure are included in the scope of the present disclosure.

The communication method as described above may be applied to not only 3GPP systems but also various wireless communication systems including IEEE 802.16x and 802.11x systems. Furthermore, the proposed method may be applied to mmWave communication system using ultra high frequency band.

What is claimed is:

1. A method for providing positioning based communication services to a user equipment (UE) in a wireless communication system, the method comprising:
transmitting a registration request message to a network;
receiving, from the network, a registration accept message as a response to the registration request message;
receiving, from the network, a communication connection release message including restricted area information related with mobility of the UE; and
reselecting a cell based on the restricted area information.

2. The method of claim 1, wherein the restricted area information related with the mobility of the UE includes a cause for the network to transmit the communication connection release message.

3. The method of claim 1, wherein in the reselecting of the cell, a cell that doe not correspond to the restricted area information related with mobility of the UE is preferentially selected.

4. The method of claim 3, further comprising:
transmitting the registration request message to the network related with the cell based on the UE staying in the cell.

5. The method of claim 1, wherein the restricted area information related with the mobility of the UE further includes information of an altitude to which the communication services from the network is not authorized for the UE.

6. The method of claim 1, wherein the network supports positioning information of the UE in a three-dimensional space of the UE

7. The method of claim 1, wherein the communication connection release message is based on the positioning information in the three-dimensional space of the UE.

8. A method for providing positioning based communication services by a network in a wireless communication system, the method comprising:
receiving a registration request message from a UE;
transmitting, to the UE, a registration accept message as a response to a registration request message;
monitoring an environment in which the UE performs communication; and
transmitting, to an entity, an alarm message indicating that a connection with the UE may be released, based on the environment in which the UE performs communication and configuration information of the UE stored in the network.

9. The method of claim 8, wherein the configuration information of the UE includes (i) information on restricted area in which the UE does not perform the communication, or (ii) contact information related with the entity.

10. The method of claim 9, wherein the alarm message is transmitted when a positioning where the UE performs communication or a positioning where the UE is expected to perform the communication correspond to a restricted area where the UE does not perform the communication.

11. The method of claim 9, wherein the information on the restricted area in which the UE does not perform the communication is set as a value indicating a height or an altitude.

12. The method of claim 8, wherein the alarm message includes time information related with a release of the communication with the UE.

13. The method of claim 8, wherein the alarm message includes the information on the restricted area in which the UE does not perform the communication.

14. The method of claim 9, wherein the registration request message includes the contact information related with the entity.

15. A method for receiving communication services from a network by a first UE in a wireless communication system, the method comprising:
transmitting a registration request message to a network;
receiving, from the network, a registration accept message as a response to the registration request message;
receiving, from the network, an alarm message indicating that a connection with the UE may be released; and
transmitting, to a second UE, a control message for controlling the second UE based on the alarm message.

16. The method of claim 15, further comprising:
transmitting the contact information of the first UE to the network,
wherein the alarm message is received through the contact information of the first UE.

17. A user equipment (UE) performing a method for receiving positioning based communication services in a wireless communication system, the UE comprising:
a transceiver;
a memory; and
a processor configured to control the transceiver and the memory,
wherein the transceiver transmits a registration request message to a network, receives, from the network, a registration accept message as a response to the registration request message, and receives a communication connection release message including restricted area information related with mobility of the UE, and
the processor reselects a cell based on the restricted area information.

18. The user equipment of claim 17, wherein the restricted area information related with the mobility of the UE includes a cause for the network to transmit the communication connection release message.

19. The user equipment of claim 17, wherein the reselecting of the cell, a cell that doe not correspond to the restricted area information related with mobility of the UE is preferentially selected.

20. The user equipment of claim 19, wherein the transceiver transmits the registration request message to the network related with the cell based on the UE staying in the cell.
